(19) United States
(12) Patent Application Publication
(10) Pub. No.: US 2020/0053296 A1
(43) Pub. Date: Feb. 13, 2020

(54) MEASUREMENT DEVICE, METHOD OF OPERATING MEASUREMENT DEVICE, AND RECORDING MEDIUM

(71) Applicant: OLYMPUS CORPORATION, Tokyo (JP)

(72) Inventor: Naofumi ENDO, Tokyo (JP)

(73) Assignee: OLYMPUS CORPORATION, Tokyo (JP)

(21) Appl. No.: 16/527,776

(22) Filed: Jul. 31, 2019

(30) Foreign Application Priority Data
Aug. 7, 2018 (JP) 2018-148559

(51) Int. Cl. H04N 5/272; H04N 13/218; G06F 3/14; G01C 11/30

(52) U.S. Cl. CPC H04N 5/272; G01C 11/30; G06F 3/14; H04N 13/218

(57) ABSTRACT

A display control unit causes a display unit to display an image and designation point information. The designation point information indicates whether or not a position of at least one designation point included in a plurality of designation points is suitable for measurement of a subject. After position information of the at least one designation point is input to an input device, the display control unit causes the display unit to display the designation point information in only a period except a non-display period. The non-display period includes at least a portion of a period from a first timing to a second timing. The first timing is a timing at which the position information of a first designation point is input to the input device. The second timing is a timing at which the position information of a second designation point is input to the input device.

### BACKGROUND OF THE INVENTION

### Field of the Invention

The present invention relates to a measurement device, a method of operating a measurement device, and a recording medium.

Priority is claimed on Japanese Patent Application No. 2018-448559, filed Aug. 7, 2018, the content of which is incorporated herein by reference.

### Description of Related Art

In recent years, in the inspection of boilers, turbines, engines, chemical plants, and the like, industrial endoscopes have been widely used for observing internal damage and corrosion. As an example of an industrial endoscope, a measurement endoscopic device is disclosed in Japanese Unexamined Patent Application, First Publication No. 2004-33487. In the measurement endoscopic device, two optical systems are provided on the tip of the endoscope. The measurement endoscopic device executes three-dimensional measurement on the basis of stereo measurement using the principle of triangulation. When a defective point such as damage is found inside an object to be inspected in the inspection, a user measures the magnitude of damage or the like using such a measurement endoscopic device. Thereby, a user can determine whether or not the object to be inspected needs to be disassembled and repaired. Therefore, it is very important for the measurement endoscopic device to be able to perform three-dimensional measurement as accurately as possible. The measurement endoscopic device executes three-dimensional measurement on the basis of the positions of designation points designated on an image by a user.

A device executes three-dimensional measurement except stereo measurement is also used. For example, a device in which means for projecting pattern light is provided on the tip of an insertion portion may be used. This device can execute three-dimensional measurement by analyzing a pattern projected onto a subject.

As described above, it is very important for the measurement endoscopic device to execute measurement as accurately as possible. Generally, a user hopes that measurement will be executed with as high a degree of measurement accuracy as possible. Therefore, it is very important to present a user with information for determining whether or not a designation point is suitable for measurement.

### SUMMARY OF THE INVENTION

According to a first aspect of the present invention, a measurement device includes an image acquisition unit, a designation point setting unit, a display control unit, and a measurement unit. The image acquisition unit acquires an image of a subject. The designation point setting unit sets a plurality of designation points on the image on the basis of position information which is input to an input device. The position information indicates a position of each designation point of the plurality of designation points in the image. The display control unit causes a display unit to display the image and designation point information. The designation point information indicates whether or not a position of at least one designation point included in the plurality of designation points is suitable for measurement of the subject. The measurement unit executes the measurement on the basis of the plurality of designation points. After the position information of the at least one of the designation points included in the plurality of designation points is input to the input device, the display control unit causes the display unit to display the designation point information in only a period other than a non-display period. The non-display period includes at least a portion of a period from a first timing to a second timing. The first timing is a timing at which the position information of a first designation point included in the plurality of designation points is input to the input device. The second timing is a timing at which the position information of a second designation point included in the plurality of designation points is input to the input device. The second designation point is different from the first designation point.

According to a second aspect of the present invention, in the first aspect, the position information of the first designation point out of the plurality of designation points may be input to the input device first. The position information of the second designation point out of the plurality of designation points may be input to the input device last. The non-display period may include the entirety of the period from the first timing to the second timing.

According to a third aspect of the present invention, in the second aspect, the measurement device may further include a determination unit that determines whether or not the position information of the second designation point has been input to the input device on the basis of a measurement mode. When the determination unit determines that the position information of the second designation point has been input to the input device, the non-display period may end. The measurement unit may execute measurement of the subject using a method based on the measurement mode.

According to a fourth aspect of the present invention, in the first aspect, after the position information of the first designation point is input to the input device, the display control unit may cause the display unit to display the designation point information of the first designation point. After the designation point information of the first designation point is displayed, the display control unit may cause the designation point information of the first designation point to be hidden. The non-display period may include the entirety of a period from a third timing to the second timing. The third timing may be a timing at which the designation point information of the first designation point is hidden.

According to a fifth aspect of the present invention, in the fourth aspect, until a predetermined time elapses after the position information of the first designation point is input to the input device, the display control unit may cause the display unit to display the designation point information.

According to a sixth aspect of the present invention the fifth aspect, while the designation point information is displayed, the designation point setting unit may stop setting the designation points.

According to a seventh aspect of the present invention, in the first aspect, the display control unit may further cause a mark to be displayed on the image on the basis of mark position information which is input to the input device. The mark position information may indicate a position of the mark on the image. When an instruction for designating the designation point is input to the input device, the designation point setting unit may set one designation point included in the plurality of designation points at the position of the mark indicated by the mark position information. The non-display period may be provided on the basis of movement of the mark.

According to an eighth aspect of the present invention, in the seventh aspect, the non-display period may include the entirety of a period in which the mark moves on the image. When the mark during movement stops, the non-display period may end.

According to a ninth aspect of the present invention, in the seventh aspect, the non-display period may include the entirety of a period in which the mark moves on the image. When the instruction for designating the first designation point is input to the input device, the non-display period may end. After the instruction for designating the first designation point is input to the input device, the non-display period may start on the basis of movement of the mark. When the instruction for designating the second designation point is input to the input device, the non-display period may end.

According to a tenth aspect of the present invention, in the seventh aspect, while the mark moves, the designation point setting unit may stop setting the designation points.

According to an eleventh aspect of the present invention, in the first aspect, the display control unit may cause the designation point information to be displayed at a position where the designation point information does not overlap the plurality of designation points.

According to a twelfth aspect of the present invention, in the first aspect, the image acquisition unit may acquire a first image and a second image mutually having a parallax. The designation point setting unit may set the plurality of designation points on the first image. The display control unit may cause the display unit to display the first image and the designation point information. The designation point information may be at least a portion of the second image.

According to a thirteenth aspect of the present invention, there is provided a method of operating a measurement device including a first step, a second step, a third step, a fourth step, and a fifth step. An image acquisition unit acquires an image of a subject in the first step. A designation point setting unit sets a plurality of designation points on the image on the basis of position information which is input to an input device in the second step. The position information indicates a position of each designation point of the plurality designation points in the image. A display control unit causes a display unit to display the image in the third step. A measurement unit executes measurement of the subject on the basis of the plurality of designation points in the fourth step. After the position information of at least one designation point included in the plurality of designation points is input to the input device, the display control unit causes the display unit to display designation point information in a period except a non-display period in the fifth step. The designation point information indicates whether or not a position of the at least one designation point included in the plurality of designation points is suitable for the measurement. The non-display period includes at least a portion of a period from first timing to a second timing. The first timing is a timing at which the position information of a first designation point included in the plurality of designation points is input to the input device. The second timing is a timing at which the position information of a second designation point included in the plurality of designation points is input to the input device. The second designation point is different from the first designation point.

According to a fourteenth aspect of the present invention, there is provided a computer readable non-transitory recording medium having a program recorded therein, the program causing a computer to execute a first step, a second step, a third step, a fourth step, and a fifth step. In the first step, the computer acquires an image of a subject. In the second step, the computer sets a plurality of designation points on the image on the basis of position information which is input to an input device. The position information indicates a position of each designation point of the plurality of designation points in the image. In the third step, the computer causes a display unit to display the image. In the fourth step, the computer executes measurement of the subject on the basis of the plurality of designation points. In the fifth step, after the position information of at least one designation point included in the plurality of designation points is input to the input device, the computer causes the display unit to display designation point information in a period except a non-display period. The designation point information indicates whether or not a position of the at least one designation point included in the plurality of designation points is suitable for the measurement. The non-display period includes at least a portion of a period from a first timing to a second timing. The first timing a timing at which the position information of a first designation point included in the plurality of designation points is input to the input device. The second timing is a timing at which the position information of a second designation point included in the plurality of designation points is input to the input device. The second designation point is different from the first designation point.

### BRIEF DESCRIPTION OF THE DRAWINGS

FIG. 1 is a perspective view showing an overall configuration of an endoscopic device according to a first embodiment of the present invention.

FIG. 2 is a block diagram showing an internal configuration of the endoscopic device according to the first embodiment of the present invention.

FIG. 3 is a block diagram showing a functional configuration of a CPU according to the first embodiment of the present invention.

FIG. 4 is a reference diagram showing a method of calculating three al coordinates of a measurement point based on stereo measurement of the first embodiment of the present invention.

FIG. 5 is a flow chart showing procedure of a measurement process in the first embodiment of the present invention.

FIG. 6 is a reference diagram showing an image in the first embodiment of present invention.

FIG. 7 is a flow chart showing a procedure of the measurement process in the first embodiment of the present invention.

FIG. 8 is a flow chart showing a procedure of the measurement process in the first embodiment of the present invention.

FIG. 9 is a reference diagram showing an image in a modification example of the first embodiment of the present invention.

FIG. 10 is a reference diagram showing an image in the modification example of the first embodiment of the present invention.

FIG. 11 is a reference diagram showing an image in the modification example of the first embodiment of the present invention.

FIG. 12 is a reference diagram showing an image in the modification example of the first embodiment of the present invention.

FIG. 13 is a flow chart showing a procedure of a measurement process in a second embodiment of the present invention.

FIG. 14 is a flow chart showing a procedure of the measurement process in the second embodiment of the present invention.

FIGS. 15A to 15C are reference diagrams showing images in the second embodiment of the present invention.

FIGS. 16A to 16C are reference diagrams showing images in the second embodiment of the present invention.

FIGS. 17A to 17C are reference diagrams showing images in the second embodiment of the present invention.

FIGS. 18A to 18C are reference diagrams showing images in the second embodiment of the present invention.

FIG. 19 is a flow chart showing a procedure of a measurement process in a third embodiment of the present invention.

FIG. 20 is a flow chart showing a procedure of a corresponding point display process in the third embodiment of the present invention.

FIGS. 21A to 21C are reference diagrams showing images in the third embodiment of the present invention.

FIGS. 22A to 22C are reference diagrams showing images in the third embodiment of the present invention.

FIGS. 23A to 23C are reference diagrams showing images in the third embodiment of the present invention.

FIGS. 24A to 24C are reference diagrams showing images in the third embodiment of the present invention.

FIG. 25 is a reference diagram showing an image in the third embodiment of the present invention.

FIG. 26 is a flow chart showing a procedure of a measurement process in a modification example of the third embodiment of the present invention.

FIGS. 27A to 27C are reference diagrams showing images in the modification example of the third embodiment of the present invention.

FIGS. 28A to 28C are reference diagrams showing images in the modification example of the third embodiment of the present invention.

FIGS. 29A to 29C are reference diagrams showing images in the modification example of the third embodiment of the present invention.

FIGS. 30A and 30B are reference diagrams showing images in the modification example of the third embodiment of the present invention.

### DETAILED DESCRIPTION OF THE INVENTION

Hereinafter,embodiments of the present invention will be described with reference to the accompanying drawings. In the following, an endoscopic device is used as an example of a measurement device.

### First Embodiment

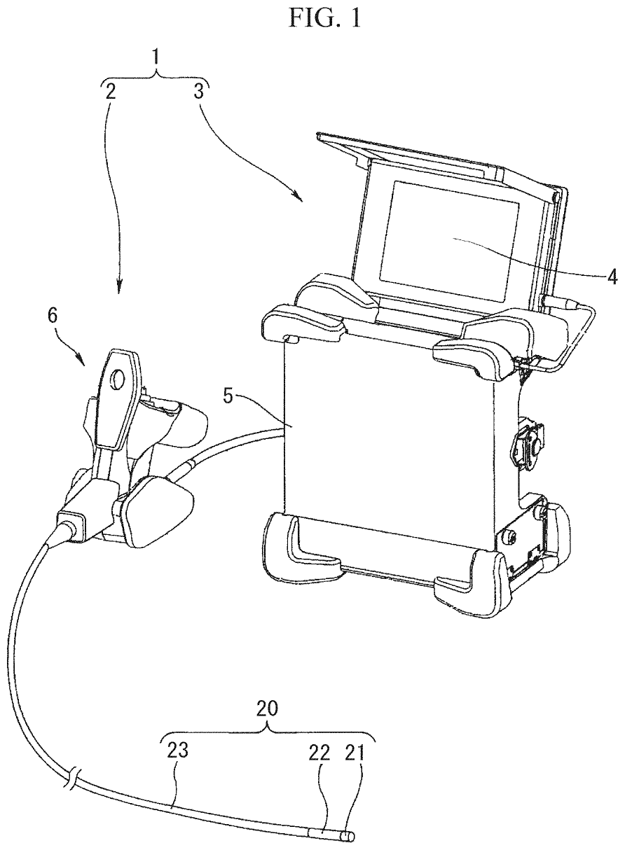

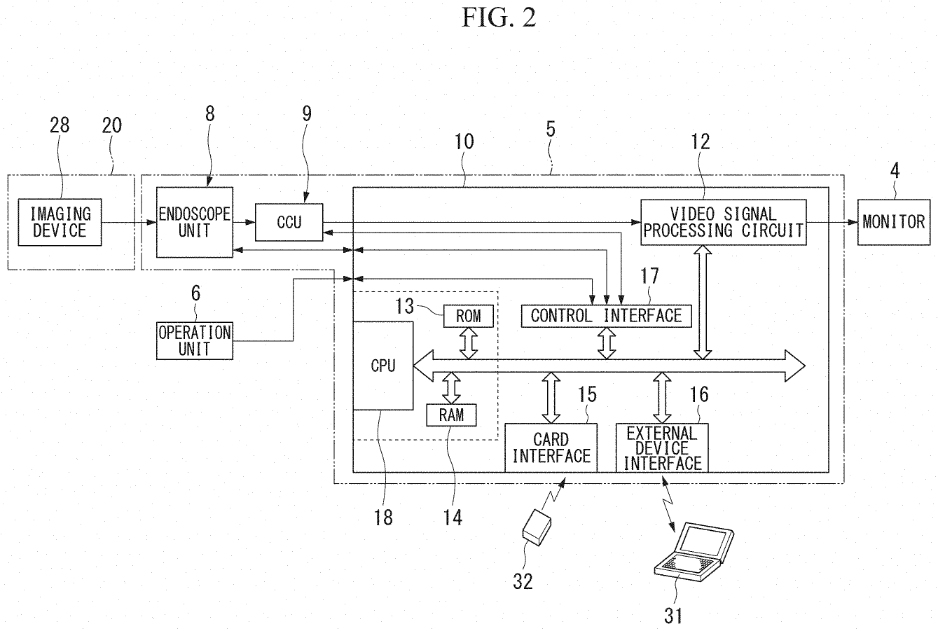

FIG. 1 shows an overall configuration of an endoscopic device 1 according to a first embodiment of the present invention. FIG. 2 shows an internal configuration of the endoscopic device 1. The endoscopic device 1 shown in FIG. 1 includes an endoscope 2 and a device main body 3. The endoscope 2 includes an elongated insertion portion 20 and an operation unit 6. A user inputs an instruction required for control of the entire device by operating the operation unit 6. The device main body 3 is connected to the endoscope 2. The device main body 3 includes a monitor 4 and a housing 5. The monitor 4 displays an image of a subject acquired by the endoscope 2, an operation menu, and the like. The housing 5 includes a control device 10 therein (see FIG. 2).

The operation unit 6 is a user interface. For example, the operation unit 6 is at least one of a button, a switch, a key, a mouse, a joystick, a touch pad, a track ball, and a touch panel. The monitor 4 is a display such as a liquid crystal display (LCD).

The insertion portion 20 is inserted into an object for inspection. The insertion portion 20 includes a hard tip portion 21, a bendable portion 22 capable of being bent, and a flexible tube portion 23 having flexibility. In the insertion portion 20, the tip portion 21 is disposed on a tip thereof. In the insertion portion 20, the flexible tube portion 23 is disposed on a main body thereof. The bendable portion 22 is disposed between the tip portion 21 and the flexible tube portion 23. An optical adaptor for forming an optical image of a subject can be attached and detached to and from the tip portion 21.

The housing 5 shown in FIG. 2 includes an endoscope unit 8, a camera control unit (CCU) 9, and a control device 10. The endoscope unit 8 includes a light source device that supplies illumination light required for observation and a bending device that bends the bendable portion 22. The CCU 9 drives the imaging device 28. The imaging signal which is output from the imaging device 28 is input to the CCU 9. The CCU 9 performs preprocessing including amplification, denoising and the like on the imaging signal acquired by the imaging device 28. The CCU 9 converts the imaging signal on which preprocessing is performed into a video signal such as an NTSC signal.

The control device 10 includes a video signal processing circuit 12, a read only memory (ROM) 13, a random access memory (RAM) 14, a card interface 15, an external device interface 16, a control interface 17, and a central processing unit (CPU) 18.

The video signal processing circuit 12 performs predetermined video processing on the video signal which is output from the CCU 9. For example, the video signal processing circuit 12 synthesizes a video signal which is output from the CCU 9 with a graphic image signal which is generated by the CPU 18. The graphic image signal includes an image of an operation screen, measurement information, and the like. The measurement information includes a cursor, a mark of a designation point, a measurement result, and the like. The video signal processing circuit 12 outputs the synthesized video signal to the monitor 4.

The ROM 13 is a non-volatile recording medium in which a program for the CPU 18 to control the operation of the endoscopic device 1 is recorded. The RAM 14 is a volatile recording medium that temporarily stores information used for the CPU 18 to control the endoscopic device 1. The CPU 18 controls the operation of the endoscopic device 1 on the basis of the program recorded in the ROM 13.

A memory card 32 which is a detachable recording medium is connected to the card interface 15. The card interface 15 reads control processing information, image information and the like stored in the memory card 32 to the control device 10. In addition, the card interface 15 records the control processing information, the image information and the like generated by the endoscopic device 1 in the memory card 32.

An external device such as a USB device is connected to the external device interface 16. For example, a personal computer 31 is connected to the external device interface 16. The external device interface 16 transmits information to the personal computer 31, and receives information from the personal computer 31. Thereby, the monitor of the personal computer 31 can display information. In addition, a user can perform an operation relating to control of the endoscopic device 1 by inputting an instruction to the personal computer 31.

The control interface 17 performs communication for operation control e operation unit 6, the endoscope unit 8, and the CCU 9. The control interface 17 notifies the CPU 18 of an instruction which is input to the operation unit 6 by a user. The control interface 17 outputs control signals for controlling the light source device and the bending device to the endoscope unit 8. The control interface 17 outputs a control signal for controlling the imaging device 28 to the CCU 9.

A program which is executed by the CPU 18 may be recorded in a computer readable recording medium. The program recorded in this recording medium may be read and executed by computers other than the endoscopic device 1. For example, the program may be read and executed by the personal computer 31. The personal computer 31 may control the endoscopic device 1 by transmitting control information for controlling the endoscopic device 1 to the endoscopic device 1 in accordance with the program. Alternatively, the personal computer 31 may acquire a video signal from the endoscopic device 1 and perform measurement using the acquired video signal.

The above-mentioned program may be transmitted from a computer that holds the program through a transmission medium or through transmitted waves in the transmission medium to the endoscopic device 1. The “transmission medium” that transmits a program refers to a medium having a function of transmitting information. The medium having a function of transmitting information includes a network (communication network) such as the Internet and a communication channel (communication line) such as a telephone line. The above-mentioned program may realize a portion of the above-mentioned functions. Further, the above-mentioned program may be a difference file (difference program). The above-mentioned functions may be realized by a combination of a program is already recorded in a computer with a difference program.

The imaging device 28 is an image sensor. The imaging device 28 is disposed at the tip of the insertion portion 20. The optical adaptor which is mounted onto the tip portion 21 includes two optical systems mutually having a parallax. The imaging device 28 has imaging surfaces disposed at image forming positions of the two optical systems. The imaging device 28 generates an imaging signal on the basis of a first optical image formed on an imaging surface by a first optical system and a second optical image formed on an imaging surface by a second optical system. That is, the imaging device 28 generates a first image and a second image. The first image corresponds to the first optical image obtained by the first optical system. The second image corresponds to the second optical image obtained by the second optical system. The first image and the second image mutually have a parallax. For example, an image corresponding to a left visual field is defined as the first image, and an image corresponding to a right visual field is defined as the second image. The image corresponding to a right visual field may be defined as the first image, and the image corresponding to a left visual field may be defined as the second image.

As described above, the endoscopic device 1 includes the imaging device 28 (image acquisition unit), the monitor 4 (display unit), and the CPU 18. The imaging device 28 captures an image of a subject and generates an imaging signal. The imaging signal includes an image of a subject. Therefore, the imaging device 28 acquires an image of a subject generated by imaging the subject. The image acquired by the imaging device 28 is input to the CPU 18 through the video signal processing circuit 12. The monitor 4 displays an image based on a video signal and designation point information to be described later.

The imaging device 28 has a function of an image acquisition unit that acquires an image of a subject. The image acquisition unit may be an image input device. For example, in a case where the personal computer 31 operates as a measurement device, the image acquisition unit is a communication interface (communications device) that executes communication with the endoscopic device 1. The image acquisition unit be a wireless communications device. The image acquisition unit may be a readout circuit that reads out an image from a recording medium having an image recorded thereon.

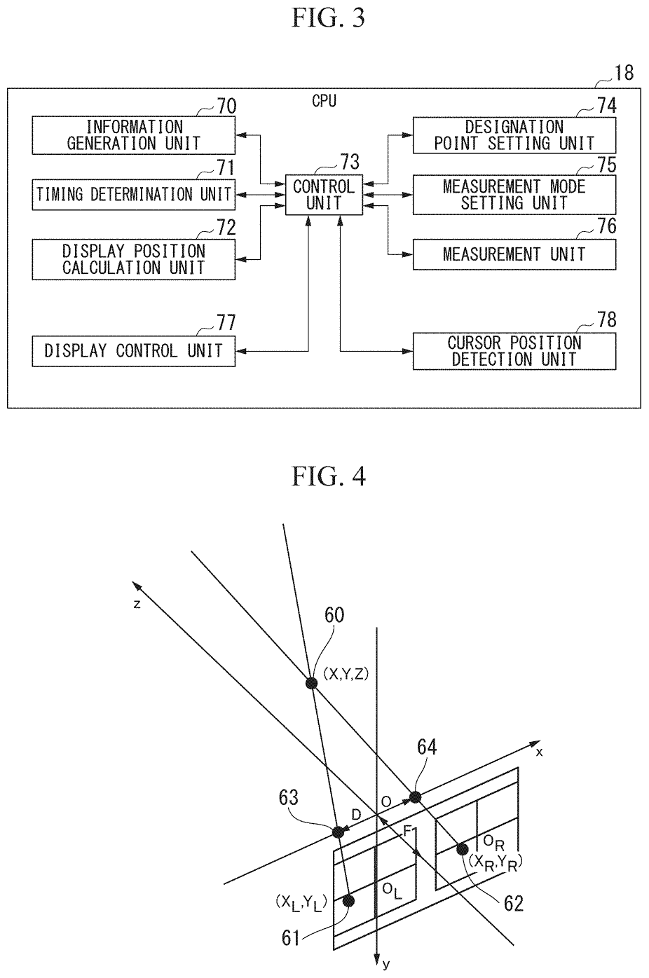

FIG. 3 shows a functional configuration of the CPU 18. The function of the CPU 18 constituted by an information generation unit 70, a timing determination unit 71, a display position calculation unit 72, a control unit 73, a designation point setting unit 74, a measurement mode setting unit 75, a measurement unit 76, a display control unit 77, and a cursor position detection unit 78. At least one of blocks shown in FIG. 3 may be constituted by a separate circuit from that of the CPU 18.

Each unit shown in FIG. 3 may be constituted by at least one of a processor and a logic circuit. For example, the processor is at least one of a CPU, a digital signal processor (DSP), and a graphics processing unit (GPU). For example, the logic circuit is at least one of an application specific integrated circuit (ASIC) and a field-programmable gate array (FPGA). Each unit shown in FIG. 3 can include one or a plurality of processors. Each unit shown in FIG. 3 can include one or a plurality of logic circuits.

An outline of a configuration shown in FIG. 3 will be described. The designation point setting unit 74 sets a plurality of designation points on an image on the basis of position information which is input to the operation unit 6 (input device). The position information indicates the position of each designation point of a plurality of designation points in an image. The display control unit 77 causes the monitor 4 to display an image and designation point information. The designation point information indicates whether or not the position of at least one designation point included in a plurality of designation points is suitable for the measurement of a subject. The measurement unit 76 executes the measurement of a subject on the basis of a plurality of designation points. After position information of at least one designation point included in a plurality of designation points is input to the operation unit 6, the display control unit 77 causes the monitor 4 to display the designation point information for only a period except a non-display period. The non-display period includes at least a portion of a period from a first timing to a second timing. The first timing is a timing at which position information of a first designation point included in a plurality of designation points is input to the operation unit 6. The second timing is a tuning at which position information of a second designation point included in a plurality of designation points is input to the operation unit 6. The second designation point is different from the first designation point.

The details of the configuration shown in FIG. 3 will be described below. The control unit 73 controls a process which is executed by each unit. The display control unit 77 causes the monitor 4 to display an image. For example, the display control unit controls a process which is executed by the video signal processing circuit 12. The display control unit 77 causes an image processed by the video signal processing circuit 12 to be output to the monitor 4. The monitor 4 displays an image which is output from the video signal processing circuit 12. For example, the display control unit 77 causes the monitor 4 to display the first image. The display control unit 77 may cause the monitor 4 to display the first image and the second image.

The display control unit 77 causes the monitor 4 to display a cursor for a user to designate a designation point. That is, the display control unit 77 causes a cursor to be displayed on an image. For example, the display control unit 77 generates a graphic image signal of a cursor. The display control unit 77 outputs the generated graphic image signal to the video signal processing circuit 12. The video signal processing circuit 12 synthesizes a video signal which is output from the CCU 9 with a graphic image signal which is output from the CPU 18. Thereby, a cursor is superimposed on an image. The video signal processing circuit 12 outputs the synthesized video signal to the monitor 4. The monitor 4 displays an image on which a cursor is superimposed. For example, the display control unit 77 causes a cursor to be displayed on the first image. The cursor is a mark for a user to designate a specific position on an image. An icon, a pointer or the like may be displayed instead of the cursor.

A user inputs position information of a cursor to the operation unit 6 by operating the operation unit 6. The operation unit 6 outputs the position information which is input to the operation unit 6 by the user. The position information which is output from the operation unit 6 is input to the control interface 17 which is an input unit. The position information input to the control interface 17 is input to the CPU 18. The cursor position detection unit 78 detects a position indicated by the position information which is input to the operation unit 6. The display control unit 77 causes a cursor to be displayed at a position indicated by the position information which is input to the operation unit 6.

The display control unit 77 causes the monitor 4 to display a mark of a designation point and a measurement result. That is, the display control unit 77 causes a mark of a designation point and a measurement result to be displayed on an image. For example, the display control unit 77 generates each graphic image signal of a mark of a designation point and a measurement result. Thereafter, the same process as a process for displaying a cursor is executed. The monitor 4 displays an image on which a mark of a designation point and a measurement result are superimposed. The mark of a designation point indicates the position of a designation point on an image.

A user inputs an instruction for designating a designation point to the operation unit 6 by operating the operation unit 6. The operation unit outputs the instruction which is input to the operation unit 6 by the user. The instruction which output from the operation unit 6 is input to the control interface 17. The instruction which is input to the control interface 17 is input to the CPU 18. When the instruction for designating a designation point is input to the operation unit 6, the designation point setting unit 74 sets one designation point included in a plurality of designation points at a position indicated by the position information of a cursor. A user repeatedly executes the above operation. Therefore, a plurality of pieces of position information are input to the operation unit 6. The designation point setting unit 74 sets a plurality of designation points by setting a designation point at a position indicated by each of the plurality of pieces of position information. Position information of a designation point which is set by the designation point setting unit 74 is held by the RAM 14. A designation point is associated with a specific image, and thus the designation point is set For example, the designation point setting unit 74 sets a plurality of designation points the first image.

The designation point is coordinate information of a position of interest determined by a user's instruction. The designation point indicates a measurement position on a subject. The designation of a designation point means that a user instructs the endoscopic device 1 on a position of a designation point. The setting of a designation point means that the designation point setting unit 74 associates the position of a designation point with an image.

A user inputs an instruction for designating a measurement mode to the operation unit 6 by operating the operation unit 6. The measurement mode is distance-between-two-points measurement, area measurement, line-based measurement, plane-based measurement, or the like. The measurement between two points is a mode for measuring a three-dimensional distance between two designation points. The area measurement is a mode for measuring the area of a three-dimensional region specified by at least three designation points. The line-based measurement is a mode for measuring a three-dimensional distance between a three-dimensional straight line specified by two designation points and one designation point. The plane-based measurement is a mode for measuring a three-dimensional distance between a three-dimensional region specified by three designation points and one designation point. The operation unit 6 outputs instruction which is input to the operation unit 6 by a user. The instruction which is output from the operation unit 6 is input to the control interface 17. The instruction which is input to the control interface 17 is input to the CPU 18. The measurement mode setting unit 75 selects any one of a plurality of measurement modes on the basis of the instruction which is input to the operation unit 6. The measurement mode setting unit 75 holds a selected measurement mode in the RAM 14. Thereby, a measurement mode is set in the endoscopic device 1. The measurement mode setting unit 75 may select a measurement mode on the basis of an image acquired by the imaging device 28.

The measurement unit 76 uses the first image and the second image to execute three-dimensional measurement of a subject on the basis of the principle of stereo measurement. Specifically, the measurement unit 76 calculates three-dimensional coordinates of the position of a designation point which is set by the designation point setting unit 74. The measurement unit 76 measures the size of a three-dimensional shape of a subject on the basis of the calculated three-dimensional coordinates.

The information generation unit 70 generates designation point information indicating whether or not the position of a designation point is suitable for the measurement of a subject. For example, the designation point information may be a luminance distribution of a region including a designation point in an image. The designation point information may be information indicating the distinction degree (edge) of a designation point. The designation point information may be texture information. The designation point information may be depth information (a distance to a subject) at the position of a designation point. The designation point information may be a reliability as an index obtained by comprehensively determining various pieces of information. The designation point information may be information different from these pieces of information. The information generation unit 70 may select designation point information displayed among a plurality of pieces of designation point information on the basis of the reliability of a designation point.

The display control unit 77 causes the monitor 4 to display designation point information. That is, the display control unit 77 causes the designation point information to be displayed on an image. For example, the display control unit 77 generates a graphic image signal of the designation point information. Thereafter, the same process as a process for displaying a cursor is executed. The monitor 4 displays an image on which the designation point information is superimposed. For example, the display control unit 77 causes the monitor 4 to display the first image and the designation point information.

In a case where the measurement unit 76 executes stereo measurement in a measurement process, the designation point information may be information of a corresponding point. The information of a corresponding point is obtained in a matching process generally known. For example, in a case where a designation point s set in the first image, a corresponding point of a position corresponding to a designation point in the second image is detected by executing the matching process. The designation point information may be at least a portion of the second image. For example, the designation point information may be an image in the vicinity of a corresponding point in the second image. The designation point information may be the entire second image. The information of a corresponding point may be a correlation value or the like calculated in the matching process.

The display position calculation unit 72 calculates a position at which the designation point information is displayed on the basis of the position of a designation point which is set by the designation point setting unit 74. For example, the display position calculation unit 72 calculates a position at which the designation point information does not overlap a designation point. The display control unit 77 causes the designation point information to be displayed at the position calculated by the display position calculation unit 72.

The timing determination unit 71 determines a timing at which the designation point information is displayed on the basis of a measurement mode and a designation point. In a case where the timing determination unit 71 determines that the designation point information is displayed, the display control unit 77 causes the monitor 4 to display the designation point information.

The display control unit 77 controls a non-display period in which the designation point information is not displayed. The non-display period includes the entirety of or a portion of a period from a first timing to a second timing. The first tinting is at which position information of a first designation point is input to the operation unit 6. The second timing is a timing at which position information of a second designation point is input to the operation unit 6. The first designation point is not necessarily a designation point which is set first. The second designation point is not necessarily a designation point which is secondly set.

For example, a non-display period may start before the position information of the first designation point out of a plurality of designation points is input. That is, a non-display period may stall before the first designation point is designated by a user. A non-display period may start simultaneously with starting of the measurement process. A non-display period continues until the position information of the second designation point is input to the operation unit 6. When the position information of the second designation point is input to the operation unit 6, a non-display period ends. That when the second designation point is designated by a user, the display control unit 77 causes the monitor 4 to display the designation point information.

In the first embodiment, the position information of the first designation point out of a plurality of designation points is input to the operation unit 6 first. In the first embodiment, the position information of the second designation point out of a plurality of designation points is input to the operation unit 6 last. In the first embodiment, a non-display period includes the entire period from the first timing to the second timing. The first timing is a timing at which position information of a first designation point is input to the operation unit 6. The second timing is a timing at which position information of a second designation point is input to the operation unit 6.

Before pieces of position information of all the designation points except the first designation point are input to the operation unit 6, the position information of the first designation point is input to the operation unit 6. After pieces of position information of all the designation points except the second designation point are input to the operation unit 6, the position information of the second designation point is input to the operation unit 6. After a non-display period ends, the display control unit 77 causes the monitor 4 to display the designation point information. That is, after the pieces of position information of all the designation points are input to the operation unit 6, the display control unit 77 causes the monitor 4 to display the designation point information. The designation point setting unit 74 sets a plurality of designation points in a non-display period.

The timing determination unit 71 determines whether or not the position information of the second designation point has been input to the operation unit 6 on the basis of a set measurement mode. When the timing determination unit 71 determines that the position information of the second designation point has been input to the operation unit 6, the non-display period ends. The measurement unit 76 executes measurement of a subject using a method based on a measurement mode.

In a predetermined measurement mode, the number of designation points is often fixed. For example, the number of designation points in the distance-between-two-points measurement may be 2. The number of designation points in the line-based measurement is 3. The number of designation points in the plane-based measurement is 4. In a case where the predetermined measurement mode is set, the timing determination unit 71 determines whether or not a predetermined number of designation points have been designated. Thereby, the timing determination unit 71 can determine a timing at which the non-display period ends.

A method in which the measurement unit 76 calculates three-dimensional coordinates will be described below. The monitor 4 displays an image based on a video signal (image data) which is input to the video signal processing circuit 12. The measurement unit 76 calculates three-dimensional coordinates corresponding to a position designated on the image. The position at which three-dimensional coordinates are calculated is a measurement position (measurement point) which is designated within the image by a user. The three-dimensional coordinates of a measurement point which is designated by a user are used for obtaining the size (measurement result) of a three-dimensional shape of a subject. As an example, a method of calculating three-dimensional coordinates based on stereo measurement will be described below.

An image is acquired in a state where a stereo optical adaptor is amounted onto the tip portion 21. The stereo optical adaptor is a dedicated lens for executing stereo measurement. The stereo optical adaptor has two right and left observation visual fields. Light from a subject is incident on the stereo optical adaptor. Two right and left subject images corresponding to the same subject are formed by the stereo optical adaptor. The two subject images are incident on the imaging device 28 and are captured by the imaging device 28. The acquired images include two subject images. Images of regions corresponding to the two subject images among the acquired images are defined as a left image (first image) and a right image (second image).

The principle of stereo measurement will be described with reference to FIG. 4. In the stereo measurement, three-dimensional coordinates of a subject are calculated using the principle of triangulation on the basis of coordinates of two optical distance measurement points. The two optical distance measurement points correspond to two subject images captured by two optical systems. The center of a line segment that links a left optical center (first optical center 63) to a right optical center (second optical center 64) is defined as an origin O. In addition, an x-axis in which the rightward direction is positive and a y-axis in which the downward direction is positive are defined. In addition, a z-axis in which a direction away from the optical system in parallel with an optical axis is positive is defined.

The three-dimensional coordinates (X, Y, Z) of a measurement point 60 are calculated using the following Expressions (1) to (3) on the basis of the principle of triangulation with respect to an image including a subject image obtained by a left optical system and a right optical system. The two-dimensional coordinates of a measurement point 61 on a left image surface on which distortion correction is performed and a corresponding point 62 on a right image surface on which distortion correction is performed are (X_{L}, Y_{L}) and (X_{R}, Y_{R}), respectively. The origins of these two-dimensional coordinates are an intersection point O_{L} and an intersection point O_{R}. The intersection point O_{L} is the intersection point between the optical axes of the left optical system and the image surface. The intersection point O_{R} is the intersection point between the optical axes of the right optical system and the image surface. A distance between the first optical center 63 and the second optical center 64 is D. A focal length is F. A parameter tis D/(X_{R}−X_{L}).

X=t×X_{R}+D/2 (1)

Y=t×Y_{R} (2)

Z=t×F (3)

In a case where the coordinates of the measurement point 61 and the coordinates of the corresponding point 62 on the image surface are determined as described above, the three-dimensional coordinates of the measurement point 60 can be obtained using the parameter D and the parameter F. Generally, in the stereo measurement, a corresponding point calculated by a matching process. In the matching process, a second position of a subject corresponding to a first position of the subject is detected. The first position of the subject is the position of the subject in an image based on light through one optical system (first optical system). The second position of the subject is the position of the subject in an image based on light through the other optical system (second optical system). There are various methods in the matching process. For example, there is a matching method in which template matching is performed. There is also a matching method in which matching is performed on the basis of a feature point such as an edge portion having light and shade. There is also a matching method in which a phase only correlation (POC) method is used. In the phase only correlation method, the correlation of a phase component obtained by performing Fourier transformation on an image is calculated. Matching methods which are applied to the embodiment of the present invention are not limited to the above matching methods.

Various measurement functions can be realized by obtaining three-dimensional coordinates of several points. For example, a distance between two points, a distance between a line that links two points and one point, the area of a region surrounded by a line that links a plurality of points, the depth of a reference plane, a surface shape, and the like are measured. A user can select a desired measurement mode from various measurement modes. In addition, it is also possible to obtain a distance (object distance) from the first optical center 63 or the second optical center 64 to a subject. The object distance is a distance from the tip portion 21 to a subject, and is, for example, a distance from the imaging device 28 or an observation optical system to a subject. Optical data indicating the characteristics of an optical system including the tip portion 21 of the insertion portion 20 and the stereo optical adaptor is required for performing the above stereo measurement. For example, the details of the matching process and the optical data are disclosed in Japanese Unexamined Patent Application, First Publication No. 2004-49638, and thus the description thereof will not be given.

A measurement method capable of being applied to the embodiment of the present invention is not limited to the stereo measurement. For example, a pattern projection system or the like may be applied to the embodiment of the present invention. In the pattern projection system, a pattern image acquired by capturing an image of pattern light projected onto a subject is analyzed. Three-dimensional coordinates are calculated on the basis of the result of the analysis.

In the pattern projection system, generally, in a case where the accuracy of detection of a pattern is low, the accuracy of the calculation result of three-dimensional coordinates deteriorates. For example, in a case where the reflectance of a subject on which the pattern light is projected is low, it is difficult to detect an accurate pattern. Alternatively, in a case where a projection portion moves while the pattern light is projected, or the like, it is difficult to detect an accurate pattern. The designation point information in the pattern projection system is, for example, the difference in a luminance value occurring due to light and darkness of a pattern. The designation point information in the pattern projection system may be the amount of blur or the like occurring when a pattern is projected.

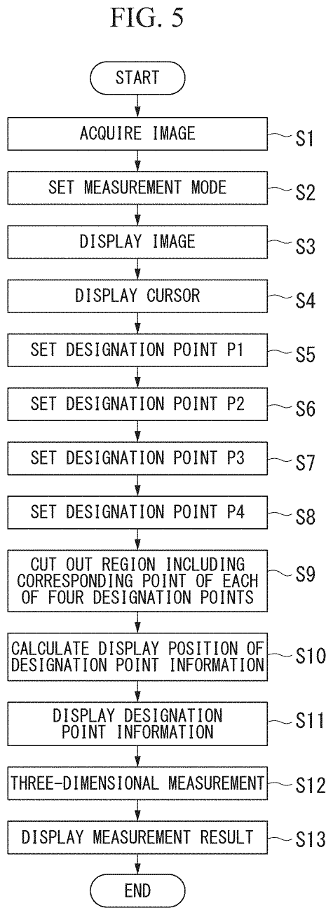

The details of the measurement process in the first embodiment will be described below. FIG. 5 shows a procedure of the measurement process. Images based on a video signal are acquired in various observation statuses. Depending on the observation status, an image that is suitable to be measured is acquired, or an image that is not suitable to be measured is acquired. The acquired image is an image recorded in the memory card 32 or an image (freeze image) temporarily recorded in the device main body 3 for the purpose of measurement. The image is not limited to a still image. For example, the image may be a video signal (LIVE proving age) which is acquired in real time. In the first embodiment, a flow of the measurement process in a case where the image is a still image will be described below.

According to a user's instruction, the CPU 18 acquires an image in a state where an object desired to be measured by the user is imaged (step S1). In this case, the imaging device 28 captures an image of a subject and generates an imaging signal. The CCU 9 generates a video signal on the basis of the imaging signal. The CPU 18 acquires the video signal, that is, the image from the CCU 9.

After the image is acquired, a user selects a desired measurement mode. The measurement mode setting unit 75 sets a measurement mode selected by a user in the endoscopic device 1 (step S2). The measurement mode setting unit 75 may select an appropriate measurement mode on the basis of the state of the image and set the measurement mode in the endoscopic device 1. Hereinafter, each process will be described by taking an example of the plane-based measurement. In the plane-based measurement, a reference plane is formed by three designation points on an image. A depth or a height between the reference plane and a fourth designation point is measured.

After the measurement mode is set, the display control unit 77 causes the monitor 4 to display an image. The monitor 4 displays an image (step S3). In the stereo measurement, two images are acquired. In step S3, only one image or two images are displayed. Hereinafter, an example in which only one image is displayed will be described.

After the image is displayed, the display control unit 77 causes the monitor 4 to display a cursor. The monitor 4 displays the cursor on the image (step S4). In step S4, the monitor 4 displays a cursor at a predetermined position on the image. For example, the monitor 4 displays a cursor at the center of the image.

After the cursor is displayed, a user can move the cursor to a desired measurement position by operating the operation unit 6. In addition, a user can designate a designation point at the desired measurement position by operating the operation unit 6. The designation point setting unit 74 determines whether or not a designation point has been designated by a user by monitoring the state of the operation unit 6. The cursor position detection unit 78 detects a position indicated by position information of the cursor on the image. When an initial designation point P1 is designated by a user, the designation point setting unit 74 sets the designation point P1 at a position indicated by the position information of the cursor on the image (step S5).

After the designation point P1 is set, the designation point setting unit 74 sets a designation point P2 at a position indicated by the position information of the cursor on the image using the same method as a method of setting the designation point P1 (step S6). After the designation point P2 is set, the designation point setting unit 74 sets a designation point P3 at a position indicated by the position information of the cursor on the image using the same method as the method of setting the designation point P1 (step S7). A reference plane is formed by three designation points P1, P2, and P3.

After the designation point P3 is set, the designation point setting unit 74 sets a final designation point P4 at a position indicated by the position information of the cursor on the image using the same method as the method of setting the designation point P1 (step S8). The designation point P4 indicates a measurement position for a depth or a height.

When the process in step S8 ends, the designation of four designation points required for the plane based measurement is completed. The timing determination unit 71 determines whether or not the fourth designation point has been designated by a user by monitoring the state of the operation unit 6. When the fourth designation point is designated, the timing determination unit 71 determines that a non-display period is ended. That is, the timing determination unit 71 determines that the designation point information is displayed. The timing determination unit 71 notifies the control unit 73 of a determination result. The control unit 73 instructs the information generation unit 70 to generate the designation point information on the basis of the determination result and instructs the display control unit 77 to display the designation point information.

In the plane-based measurement, when four designation points are designated, the designation of designation points is completed. For example, in the distance-between-two-points measurement, when two designation points are designated, the designation of designation points is completed. In the line-based measurement, when three designation points are designated, the designation of designation points is completed.

After the designation point P4 is set, the information generation unit 70 generates the designation point information (step S9). There are various aspects of the designation point information. Hereinafter, the designation point information is an image of a peripheral region of a corresponding point of each designation point. The measurement unit 76 calculates a corresponding point of each of four designation points by executing the matching process. That is, the measurement unit 76 calculates four corresponding points. The information generation nit 70 accepts corresponding point information calculated by the measurement unit 76 from the control unit 73. The information generation unit 70 cuts out a region including the four corresponding points from the second image. The information generation unit 70 generates four pieces of designation point information by cutting out four regions from the second image.

After the pieces of designation point information are generated, the display position calculation unit 72 calculates display positions of the pieces of designation point information (step S10). The display position calculation unit 72 calculates region in which the designation point information and the designation point do not overlap each other in the vicinity of each designation point. The display position calculation unit 72 notifies the control unit 73 of coordinate information of the region. The control unit 73 notifies the display control unit 77 of coordinate information of the region in which the designation point information is displayed.

After the display position of the designation point information is calculated, the display control unit 77 causes the monitor 4 to display the designation point information. The monitor 4 displays the designation point information on the first image (step S11).

After the designation point information is displayed, the measurement unit 76 executes three-dimensional measurement on the basis of four designation points (step S12). In the case of the stereo measurement, three-dimensional measurement is executed in accordance with the measurement principle described with reference to FIG. 4. The measurement unit 76 notifies the control unit 73 of a measurement result. The control unit 73 notifies the display control unit 77 of the measurement result.

After the three-dimensional measurement is ended, the display control unit 77 causes the monitor 4 to display the measurement result (step S13). When the process step S13 ends, the measurement process ends.

When the measurement process shown in FIG. 5 starts, a non-display period starts. When the designation point information is displayed in step S11, the non-display period ends.

FIG. 5 shows one example of a flow of processes. A flow of processes for obtaining the effect of the embodiment of the present invention is not limited to FIG. 5. For example, the process in step S12 may be executed be ween the process in step S8 and the process in step S9.

The designation point information of only some of a plurality of designation points may be displayed. For example, the information generation unit 70 may calculate the above-described reliability for each designation point. The information generation unit 70 may generate the designation point information of only a designation point having low reliability. The display control unit 77 may cause the monitor 4 to display the designation point information of only the designation point having low reliability.

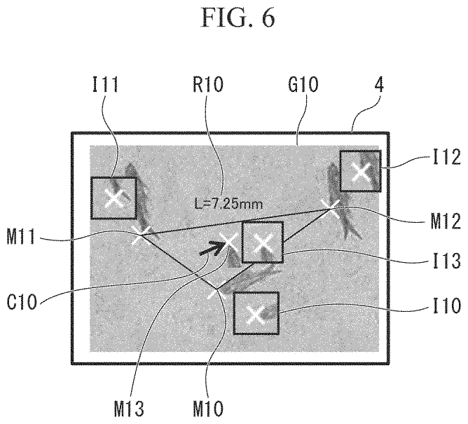

FIG. 6 shows an image displayed on the monitor 4. A first image G10 is displayed. The mark of each designation point is displayed at the position of each designation point on the first image G10. In FIG. 6, four marks M10, M11, M12, and M13 are displayed. A cursor C10 and a measurement result R10 are displayed on the first image G10. A state when the fourth designation point is designated is shown in FIG. 6. Four pieces of designation point information I10, I11, I12, and I13 are displayed on the first image G10. Each piece of designation point information is an image in the vicinity of a corresponding point of each designation point. Each piece of designation point information is generated by cutting out a portion of a region from a second image paired with the first image G10. Each piece of designation point information includes the mark of a corresponding point. The mark of a corresponding point is displayed at the position of a corresponding point in the second image.

The designation point information I10 is displayed in the vicinity of the mark M10 and does not overlap the mark M10. The designation point information I11 is displayed in the vicinity of the mark M11 and does not overlap the mark M11. The designation point information I12 is displayed in the vicinity of the mark M12 and does not overlap the mark M12. The designation point information I13 is displayed in the vicinity of the mark M13 and does not overlap the mark M13. Each piece of designation point information may be an enlarged image or a reduced image.

The measurement result R10 does not overlap each designation point. In addition, the measurement result R10 does not overlap each piece of designation point information. The display position calculation unit 72 calculates a position for displaying the measurement result R10 on the basis of the position of each piece of designation point information. For example, the display position calculation unit 72 calculates a position at which the measurement result R10 does not overlap each piece of designation point information. The display control unit 77 causes the measurement result R10 to be displayed at the position calculated by the display position calculation unit 72.

The four pieces of designation point information I10, I11, I12, and I13 do not overlap one another. For example, the display position calculation unit 72 calculates positions at which a plurality of pieces of designation point information do not overlap one another. The display control unit 77 causes the plurality of pieces of designation point information to be displayed at the positions calculated by the display position calculation unit 72.

A user determines whether or not the position of a designation point is suitable for measurement of a subject by confirming the designation point information. In a case where the position of a designation point in the first image and the position of a corresponding point in the second image are the same as each other, a user can determine that the position of the designation point is suitable for the measurement of a subject. In a case where the position of a designation point in the first image and the position of a corresponding point in the second image are different from each other, a user can determine that the position of the designation point is not suitable for the measurement of the subject.

In a case where the position of the designation point is not suitable for the measurement of the subject, a user may re-designates any designation point. Alternatively, a new image may be acquired and the measurement process may be executed again using the image. The endoscopic device 1 can obtain a more accurate measurement result through the correspondence thereof.

In a case where a user re-designates any designation point, the user selects a designation point desired to be corrected. For example, in a case where ouch panel can be used, a user may touch the position of a designation point desired to be corrected. For example, in a case where a user moves a cursor through a remote control, the user may move the cursor to the position of a designation point desired to be corrected and press a determination button. For example, in a case where there is a correction button on the monitor 4, a user may select a designation point desired to be corrected through a touch panel, a remote control or the like and press the correction button. In correction work after a designation point to be corrected is selected, the designation of a designation point is not completed. Therefore, the designation point information is hidden.

In the first embodiment, when the designation of all the designation points is completed, the designation point information is displayed. In a case where second measurement is executed using the same image as an image used in first measurement, the designation point information displayed in the first measurement is unnecessary. For example, when a user notifies a device of transition to the second measurement, the display control unit 77 may not display the designation point information displayed in the first measurement. For example, a button for giving an instruction for transition to the next measurement may be displayed on the monitor 4. Alternatively, a button for hiding the designation point information displayed in the first measurement may be displayed on the monitor 4.

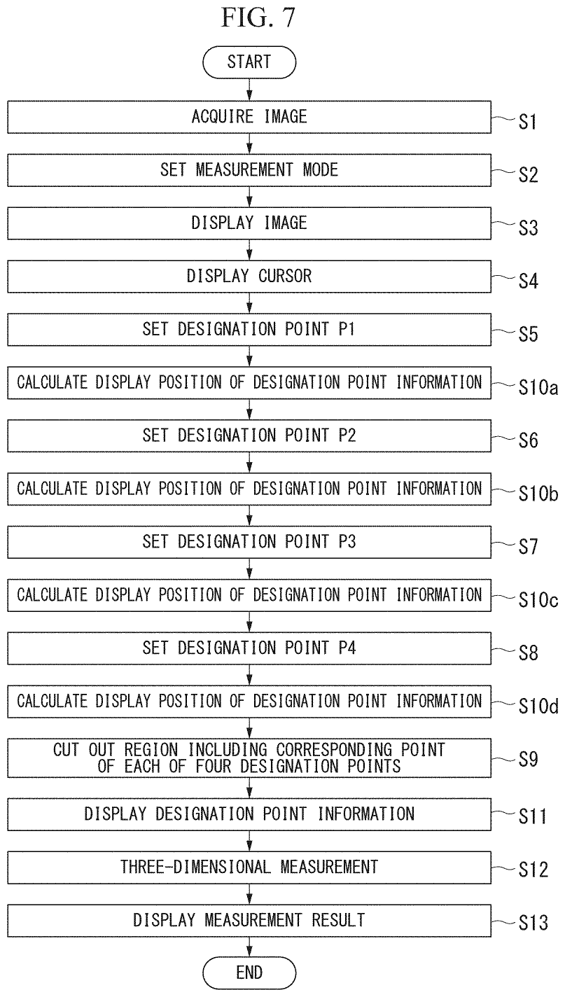

FIG. 7 shows a procedure of a measurement process different from the measurement process shown in FIG. 5. The same process as the process shown FIG. 5 will not be described.

In the measurement process shown in FIG. 5, after all the designation points set, the display position of the designation point information is calculated. In the measurement process shown in FIG. 7, whenever one designation point is set, the display position of the designation point information is calculated.

After step S5, the display position calculation unit 72 calculates the display position of the designation point information of the designation point P1 which in step S5 (step S10a). After step S10a, the process in step S6 is executed.

After step S6, the display position calculation unit 72 calculates the display position of the designation point information of the designation point P2 which is set in step S6 (step S10b). After step S10b, the process in step S7 is executed.

After step S7, the display position calculation unit 72 calculates the display position of the designation point information of the designation point P3 which is set in step S7 (step S10c). After step S10c, the process in step S8 is executed.

After step S8, the display position calculation unit calculates the display position of the designation point information of the designation point P4 which is set in step S8 (step S10d). After step S10d, the process in step S9 is executed.

The display position calculation unit 72 may confirm that each piece of designation point information does not overlap each designation point in step S11. In a case where it can be confirmed that each piece of designation point information does not overlap each designation point, the display position calculation unit 72 may cause the monitor 4 to display the designation point information in step S11. In a case where at least one piece of designation point information overlaps at least one designation point, the display position calculation unit 72 may calculate a position at which the designation point information does not overlap the designation point again.

In the process shown in FIG. 5 or 7, whenever one designation point is set, the designation point information of the designation point may be generated. In that case, after a designation point designated by a user last is set on an image, the designation point information is displayed.

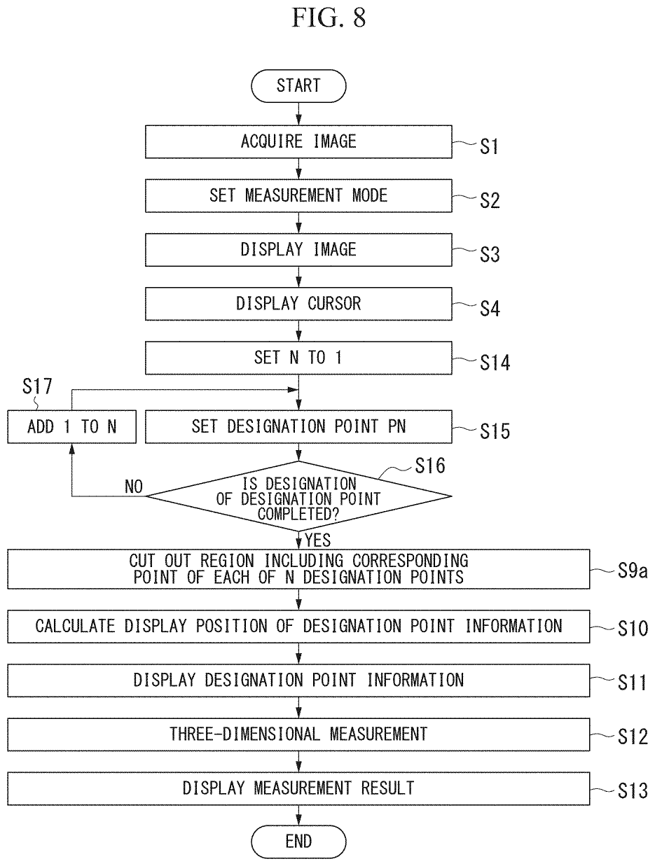

FIG. 8 shows a procedure of the measurement process which is executed when two or more designation points are set. FIG. 8 shows a process in which the process shown in FIG. 5 is generalized. The same process as the process shown in FIG. 5 will not be described. In a case where four designation points are set, the process shown in FIG. 8 is the same as the process shown in FIG. 5.

After step S4, a variable N is set to 1 (step S14). After step S14, the designation point setting unit 74 executes the same process as the process in step S5 shown in FIG. 5, to thereby set a designation point PN at a position indicated by the position information of the cursor on the image (step S15). The designation point PN is a designation point which is N-th set.

After step S15, the timing determination unit 71 determines whether or not the position information of the final designation point has been input to the operation unit 6. That is, the timing determination unit 71 determines whether or not the designation of designation points has been completed (step S16). The number of designation points required for the measurement process varies for each measurement mode. Therefore, the timing determination unit 71 can determine whether or not the designation of designation points has been completed on the basis of a set measurement mode and the number of designation points which are already designated by a user.

When an explicit instruction indicating that the designation of designation points has been completed is input to the operation unit 6 by a user, the timing determination unit 71 may determine that the designation of designation points has been completed. For example, in the area measurement, the timing determination unit 71 can determine that the designation of designation points has been completed on the basis of an explicit instruction from a user.

In step S16 in a case where the timing determination unit 71 determines that the designation of designation points has not been completed, 1 is added to the variable N (step S17). After step S17, the next designation point is set in step S15.

In step S16, in a case where the timing determination unit 71 determines that the designation of designation points has been completed, the information generation unit 70 generates the designation point information of each of N designation points by executing the same process as the process in step S9 shown FIG. 5 (step S9a). After step S9a, the process in step S10 is executed.

A method of operating an endoscopic device in each aspect of the present invention dudes first to fifth steps. The imaging device 28 acquires an image subject in the first step (step S1). The designation point setting unit 74 sets a plurality of designation points on the image on the basis of the position information which is input to the operation unit 6 in the second step (steps S5 to S8). The display control unit 77 causes the monitor 4 to display the image in the third step (step S3). The measurement unit 76 executes the measurement of the subject on the basis of the plurality of designation points in the fourth step (step S12). After the position information of at least one designation point included in the plurality of designation points is input to the operation unit 6, the display control unit 77 causes the monitor 4 to display the designation point information in the fifth step (step S11) in only a period other than a non-display period. The method of operating an endoscopic device in each aspect of the present invention does need to include steps other than the first to fifth steps.

In the endoscopic device 1 of the first embodiment, the display control unit 77 causes the monitor 4 to display the designation point information in only a period other than a non-display period. The designation point information indicates whether or not the position of at least one designation point is suitable for the measurement of a subject. The non-display period includes at least a portion of a period from the first timing to the second timing. The first tinting is a timing at which position information of a first designation point is input operation unit 6. The second timing is a timing at which position information of a second designation point is input to the operation unit 6. After the designation of at least the first designation point is ended, the designation point information is displayed. The designation point information is not likely to interfere with a user's operation designating a designation point. Therefore, the endoscopic device 1 can present a user with information indicating whether or not the position of the designation point is suitable for the measurement of a subject and can suppress deterioration in the operability of the device.

Since the designation point formation is displayed, it is easy for a user to determine whether or not a correct measurement result is obtained. In a case where the position of the designation point is not suitable for the measurement, a user can perform the measurement again.

The display control unit 77 causes the designation point information to be displayed at a position where the designation point information does not overlap a plurality of designation points. Therefore, when a user confirms the position of the designation point, the designation point information is not likely to lower visibility. Therefore, the efficiency of a user's work is not likely to deteriorate. For example, in a case where an image in the vicinity of a corresponding point displayed as the designation point information, it is considered that a user determines whether or not the position of the designation point is suitable for the measurement by comparing the position of the designation point with the position of the corresponding point. In a case where the designation point is hidden by the designation point information, a user cannot compare the position of the designation point with the position of the corresponding point. Even in a case where a user can operate the designation point information that overlaps the designation point, work is complicated. Since the designation point information does not overlap the designation point, operability is further improved.

Similarly since the measurement result does not overlap the designation point information, operability is further improved. Since a plurality of pieces of designation point information do not overlap one another, operability is further improved.

The timing determination unit 71 determines a timing at which the designation of designation points is ended on the basis of the measurement mode, that is, a timing at which the non-display period ends. A user need not notify a device of the end of the designation of designation points. Therefore, a user burden is alleviated.

### Modification Example of First Embodiment

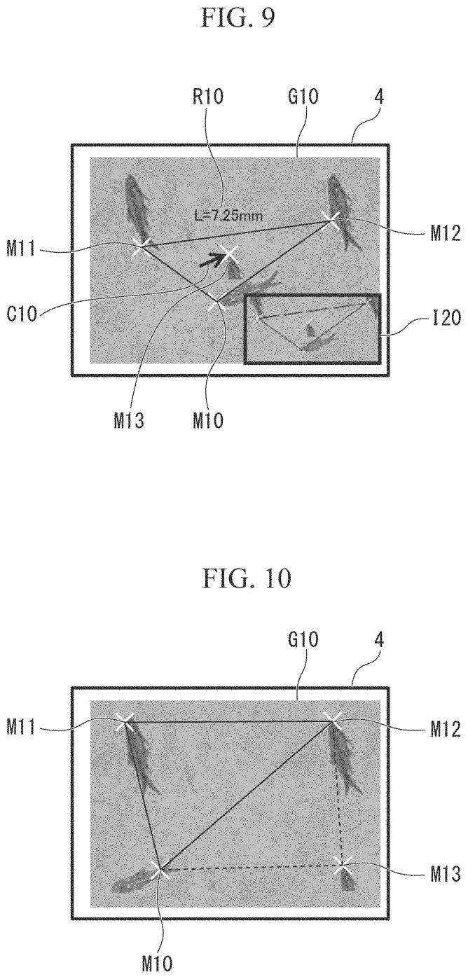

A modification example of the first embodiment of the present invention will be described below. FIG. 9 shows an image which is displayed on the monitor 4. The same portions as those shown in FIG. 6 will not be described.

Designation point information I20 is displayed on the first image G10 instead of the pieces of designation point information I10, I11, I12, and I13 shown in FIG. 6. The pieces of designation point information include images in the vicinity of the corresponding points of all the designation points. Each piece of designation point information is generated by cutting out a portion of a region from a second image paired with the first image G10. For example, the designation point information is a reduced image of a region including all the corresponding points on the second image.

The information generation unit 70 may select any one of first designation point information and second designation point information on the basis of the measurement mode. The first designation point information is designation point information of each designation point. The first designation point Information is generated by cutting out a region including the corresponding point of each designation point from the second image paired with the first image G10. The second designation point information is designation point information corresponding to all the designation points. The second designation point information is generated by cutting out a region including the corresponding points of all the designation points from the second image paired with the first image G10. The display control unit 77 may cause the monitor 4 to display the selected designation point information.

For example, in a case where the measurement mode is the measurement between two points or the line-based measurement, the information generation unit 70 selects the first designation point information. That is, in a case where a measurement mode having a small number of designation points is set, the information gene ration 70 selects the first designation point information. In a case where the measurement mode is the area measurement or the plane-based measurement, the information generation unit 70 selects the second designation point information. That is, in a case where a measurement mode having number of designation points is set, the information generation unit 70 selects the second designation point information.

The information generation unit 70 may select any one of the first designation point information and the second designation point information on the basis of the position of the designation point. For example, the information generation unit 70 compares the size of a region surrounded by a plurality of designation points with the size of the image. The region is a region surrounded by line segment that links three or more designation points which are disposed outermost. In a case where the size of the region is more than a half of the size of the image, the information generation unit 70 selects the first designation point information. In a case where the size of the region is smaller than a half of the size of the image, the information generation unit 70 selects the second designation point information.

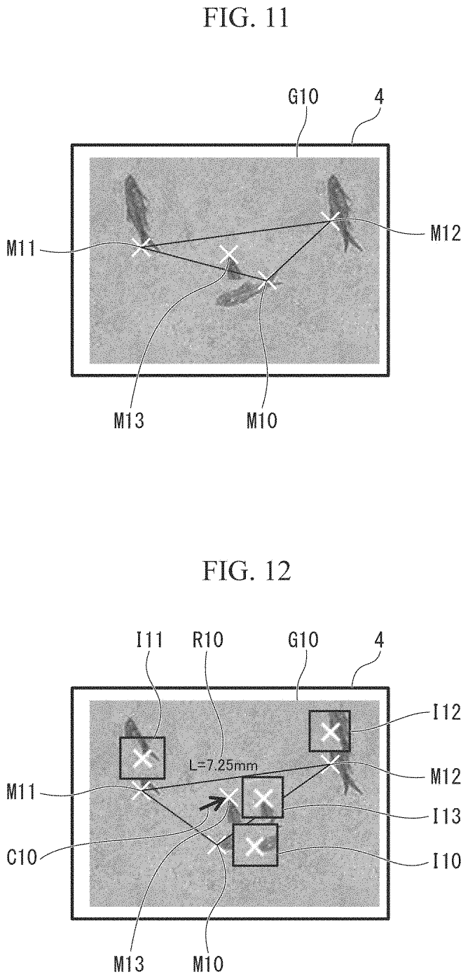

FIGS. 10 and 11 show images which are displayed on the monitor 4. The same portions as those shown in FIG. 6 will not be described. In FIG. 10, the size of a region surrounded by four designation points is more than a half of the size of the first image G10. In this case, the information generation unit 70 selects the first designation point information. That is, the designation point information including one corresponding point is displayed for each designation point. In FIG. 10, the designation point information is omitted.

In FIG. 11, the size of a region surrounded by four designation points is smaller than a half of the size of the first image G10. In this case, the information generation unit 70 selects the second designation point information. That is, the designation point information including the corresponding points of all the designation points is displayed. In FIG. 11, the designation point information is omitted.

The display form of the designation point information varies depending on the density of a plurality of designation points. Therefore, it is easy for a user to compare the position of the designation point with the position of the corresponding point.

The display control unit 77 may cause the designation point information of each designation point to be displayed at a position away from the designation point in a horizontal direction or a vertical direction. FIG. 12 shows an image which is displayed on the monitor 4. The same portions as those shown in FIG. 6 will not be described. Each designation point and the corresponding point are lined up in a horizontal direction or a vertical direction. A designation point indicated by the mark M10 and a corresponding point in the designation point information I10 are lined up in a horizontal direction. A designation point indicated by the mark M11 and a corresponding point in the designation point information I11 are lined up in a vertical direction. A designation point indicated by the mark M12 and a corresponding point in the designation point information I12 are lined up in a vertical direction. A designation point indicated by the mark M13 and a corresponding point in the designation point information I13 are lined up in a horizontal direction.

A user determines whether or not the position of the designation point is suitable for the measurement by paring the position of the designation point with the position of the corresponding point. Since the designation point and the corresponding point are lined up in a horizontal direction or a vertical direction, it is easy for a user to compare the position of the designation point with the position of the corresponding point.

Similarly to FIG. 9, each piece of designation point information may not overlap a straight line that links one designation point to another designation point. For example, the display position calculation unit 72 calculates a position for displaying the designation point information on the basis of the position of each designation point. For example, the display position calculation unit 72 calculates a position at which the designation point information does not overlap the above straight line. The display control unit 77 causes the designation point information to be displayed at a position calculated by the display position calculation unit 72.

The designation point information is displayed at a position where the information does not overlap a straight line that links one designation point to another designation point. Therefore, it is easy for a user to compare the position of the designation point with the position of the corresponding point.

A method of controlling a display position of designation point information is not limited to the above method. For example, the display control unit 77 may control the display position of designation point information on the basis of the type of designation point information or the reliability of a designation point.

### Second Embodiment

A second embodiment of the present invention will be described using the endoscopic device 1 of the first embodiment. After the position information of the first designation point is input to the operation unit 6, the display control unit 77 causes the monitor 4 to display the designation point information of the first designation point. After the designation point information of the first designation point is displayed on the monitor 4, the display control unit 77 causes the designation point information of the first designation point to be hidden. The non-display period includes the entirety of a period from a third timing to the second timing. The third timing is a timing at which the designation point information of the first designation point is hidden. The second timing is a timing at which the position information of the second designation point is input to the operation unit 6. The first designation point is not necessarily a designation point which is set first. The second designation point is not necessarily a designation point which is secondly set. The second designation point is a designation point which is set next to the first designation point.

Until the non-display period starts after the position information of the first designation point is input to the operation unit 6, the display control unit 77 causes the monitor 4 to display the designation point information. The display period of the designation point information is a period of a predetermined length. Until a predetermined time elapses after the position information of the first designation point is input to the operation unit 6, the display control unit 77 causes the monitor 4 to display the designation point information. When the predetermined time has elapsed, the non-display period starts. While the designation point information is displayed, the designation point setting unit 74 stops setting the designation point regardless of a user's operation. While the designation point information is displayed, the display control unit 77 may fix the display position of a cursor regardless of a user's operation. That is, while designation point information is displayed, the movement of the cursor may be stopped.

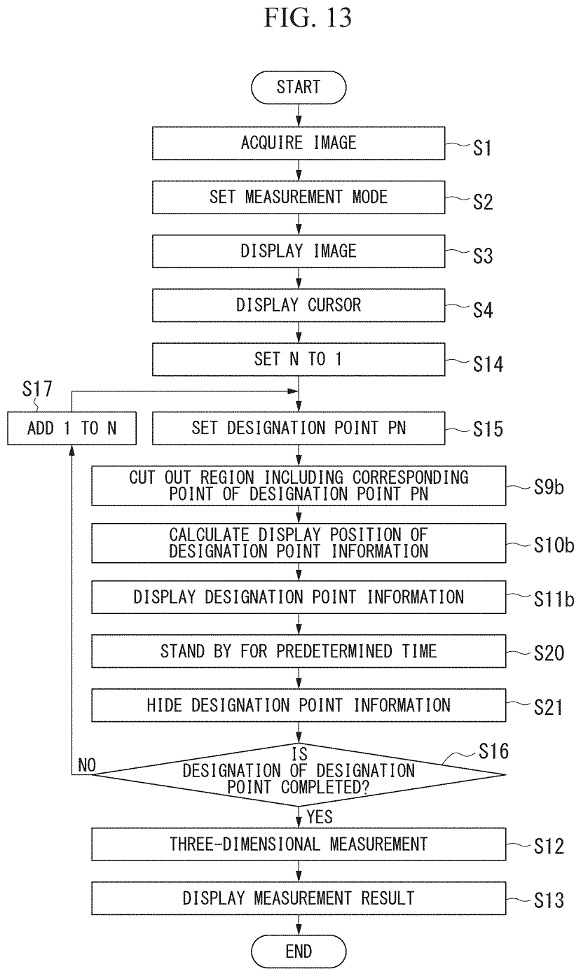

FIG. 13 shows a procedure of the measurement process. The same process as the process shown in FIG. 8 will not be described.

After step S15, the information generation unit 70 generates the designation point information (step S9b). For example, the designation point information is an image of a peripheral region of the corresponding point of each designation point. The measurement unit 76 calculates the corresponding point of the designation point PN set in step S15 by executing the matching process. The information generation unit 70 accepts the corresponding point information calculated by the measurement unit 76 from the control unit 73. The information generation unit 70 generates the designation point information by cutting out a region including the corresponding point from the second image.

After the designation point information is generated, the display position calculation unit 72 calculates the display position of the designation point information (step S10b). After the display position of the designation point information is calculated, the display control unit 77 causes the monitor 4 to display the designation point information (step b). In the measurement process shown in FIG. 13, whenever one designation point is set, the designation point information is generated and the designation point information is displayed.

After the designation point information is displayed, the timing determination unit 71 stands by for a predetermined time (step S20). The display control unit 77 continues to cause the monitor 4 to display the designation point information. The timing determination unit 71 determines a timing at which the non-display period starts on the basis of a time having elapsed from when the process of step S11b is executed. When the predetermined time has elapsed, the timing determination unit 71 determines that the non-display period starts. That is, the timing determination unit 71 determines that the designation point information is to be hidden. The timing determination unit 71 notifies the control unit 73 of a determination result. The control unit 73 instructs the display control unit 77 to hide the designation point information on the basis of the determination result.

In step S20, information of a predetermined time is used. The information of the predetermined time is used in the determination of a timing at which the non-display period starts. For example, the information of the predetermined time is recorded in advance in the memory of the endoscopic device 1. A user ay input the information of the predetermined time to the operation unit 6.

After the predetermined time has elapsed, the display control unit 77 causes the designation point information to be hidden (step S21). The monitor 4 stops displaying the designation point information. After the designation point information is hidden, the process in step S16 is executed.

In step S16, in a case where the timing determination unit 71 determines that the designation of designation points is not completed, the process in step S17 is executed similarly to the process shown in FIG. 8. In step S16, in a case where the timing determination unit 71 determines that the designation of designation points has been completed, the process in step S12 is executed.

When the measurement process shown in FIG. 13 starts, the non-display period starts. When the designation point information is displayed in step S11b, the non-display period ends. When the designation point information is displayed and the predetermined time has elapsed, the designation point information is hidden in step S21. In this case, the non-display period starts. Until the next designation point information is displayed, the non-display period continues.

Until the non-display period starts step S21 after the designation point is set in step S15, the designation point setting unit 74 does not accept the designation of the designation point. The position information of the designation point which is input to the operation unit 6 in this period becomes invalid. In this period, the designation point setting unit 74 stops setting the designation points. In the non-display period, the designation point setting unit 74 accepts the designation of the designation point and sets the designation point.

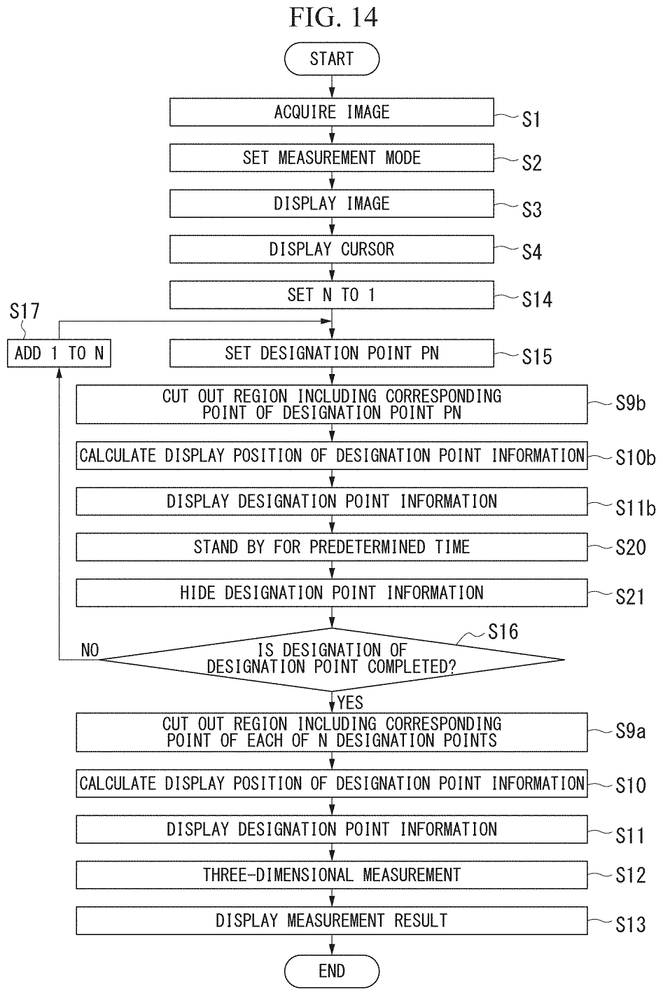

FIG. 14 shows a procedure of a measurement process different from the measurement process shown in FIG. 13. The same process as the process shown in FIG. 13 will not be described.

In step S16, in a case where the timing determination unit 71 determines that the designation of designation points has been completed, the process in each of steps S9a, S10, and S11 is executed similarly to the process shown in FIG. 8. After step S11, the process in step S12 is executed.

In the measurement process shown in FIG. 13, after the designation of all the designation points is completed, the designation point information is not displayed. In the measurement process shown in FIG. 14, after the designation of all the designation points completed, the designation point information of each of all the designation points is displayed. A user can finally confirm the positions of all the designation points collectively.

There are various aspects of processes executed after the designation of all the designation points is completed. For example, after the designation of all the designation points is completed, the designation point information of each of all the designation points may be displayed only for a predetermined time. After the designation of all the designation points is completed, the designation point information of only a designation point having low reliability may be displayed.

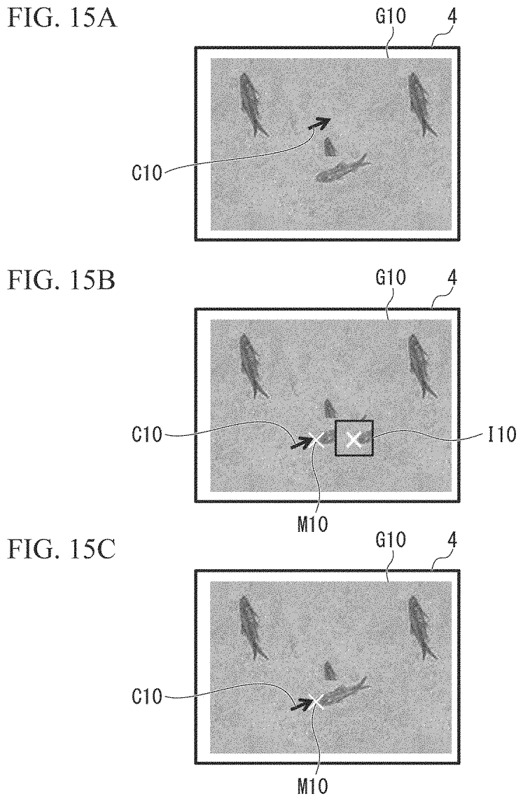

FIGS. 15A to 18C show the states of the monitor 4 when the measurement process shown in FIG. 13 is executed. In step S3, the first image G10 shown in FIG. 15A is displayed on the monitor 4. In step S4, the cursor C10 shown in FIG. 15A is displayed on the first image G10. For example, the cursor C10 is an arrow. The position of the tip of the cursor C10 is the position of the cursor C10.

A user moves the cursor C10 on the first image G10 by operating the operation unit 6. When the designation point is set on the first image G10 in step S15, the mark M10 shown FIG. 15B is displayed on the first image G10. The position of the mark M10 is the same as the position of the cursor C10. Thereafter, in step S11b, the designation point information I10 shown in FIG. 15B is displayed on the first image G10. The designation point information I10 does not overlap the mark M10. A user compares a designation point indicated by the mark M10 with a corresponding point indicated by the designation point information I10. When a predetermined time has elapsed after the designation point information I10 is displayed, the designation point information I10 is hidden in step S21 (FIG. 15C).

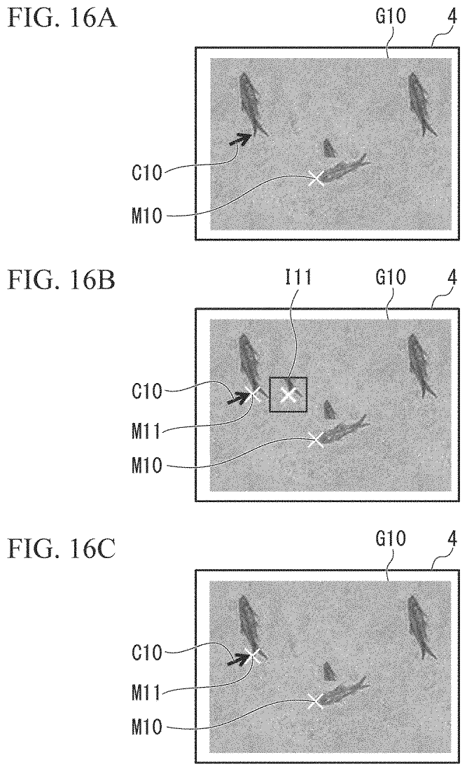

A user moves the cursor C10 on the first image G10 by operating the operation unit 6 in order to designate the next designation point (FIG. 16A). When the designation point is set on the first image G10 in step S15, the mark M11 shown in FIG. 16B is displayed on the first image G10. The position of the mark M11 is the same as the position of the cursor C10. Thereafter, in step S11b, the designation point information I11 shown in FIG. 16B is displayed on the first image G10. The designation point information I11 does not overlap the mark M11. A user compares a designation point indicated by the mark M11 with a corresponding point indicated by the designation point information I11. When a predetermined time has elapsed after the designation point information I11 is displayed, the designation point information I11 is hidden in step S21 (FIG. 16C).

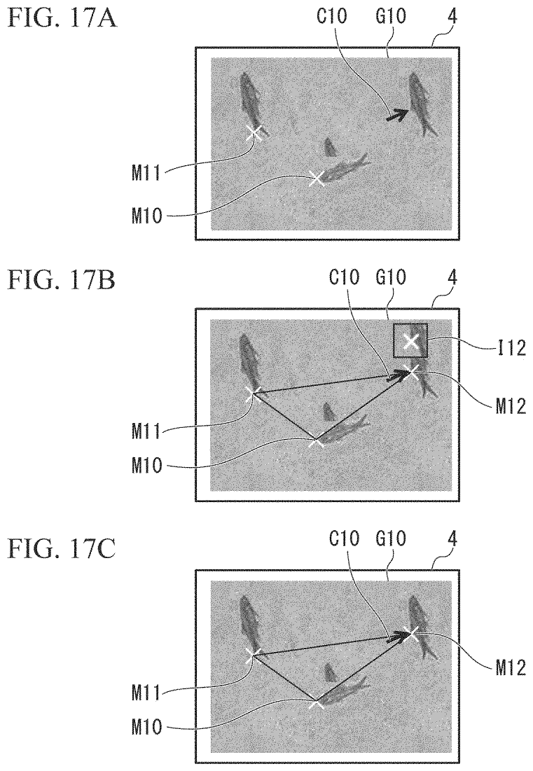

A user moves the cursor C10 on the first image G10 by operating the operation unit 6 in order to designate the next designation point (FIG. 17A). When the designation point is set on the first image G10 in step S15, the mark M12 shown in FIG. 17B is displayed on the first image G10. The position of the mark M12 is the same as the position of the cursor C10. Thereafter, in step S11b, the designation point information I12 shown in FIG. 17B is displayed on the first image G10. The designation point information I12 does not overlap the mark M12. A user compares a designation point indicated by the mark M12 with a corresponding point indicated by the designation point information I12. When a predetermined time has elapsed after the designation point information I12 is displayed, the designation point information I12 is hidden in step S21 (FIG. 17C).

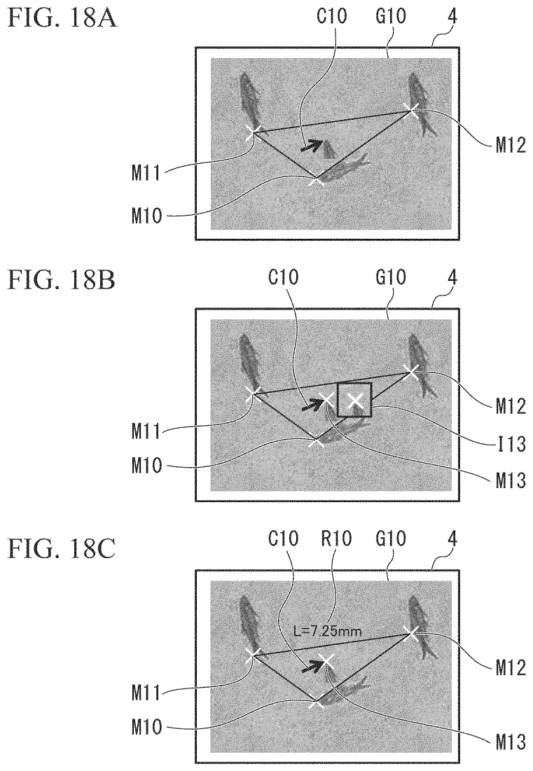

A user moves the cursor C10 on the first image G10 by operating the operation unit 6 in order to designate the next designation point (FIG. 18A). When the designation point is set on the first image G10 in step S15, the mark M13 shown in FIG. 18B is displayed on the first image G10. The position of the mark M13 is the same as the position of the cursor C10. Thereafter, in step S11b, the designation point information I13 shown in FIG. 18B is displayed on the first image G10. The designation point information I13 does not overlap the mark M13. A user compares a designation point indicated by the mark M13 with a corresponding point indicated by the designation point information I13. In a case where the plane-based measurement is set in the endoscopic device 1, the designation of all the designation points is completed when four designation points are set. When a predetermined time has elapsed after the designation point information I13 is displayed, the designation point information I13 is hidden in step S21 (FIG. 18C). In step S13, the measurement result RIO shown in FIG. 18C is displayed on the first image G10.

There are various display positions of the designation point information. The designation point information does not overlap each designation point. In order for a user to easily compare the position of the designation point with the position of the corresponding point, the designation point information may be displayed at a position away from the designation point in a horizontal direction or a vertical direction. The measurement result may be displayed at a position where the result does not overlap the designation point information. A plurality of pieces of designation point information may be displayed at positions where these pieces of designation point information do not overlap one another. The designation point information may be displayed at a position where the information does not overlap a straight line that links one designation point to another designation point.

In the endoscopic device 1 of the second embodiment, after each designation point is designated, the display control unit 77 causes the monitor 4 to display the designation point information. Whenever a user designates the designation point, the user can determine whether or not the position of the designation point is suitable for the measurement of a subject.

Until a predetermined time has elapsed from when the position information of each designation point is input to the operation unit 6, the display control unit 77 causes the monitor 4 to display the designation point information. Since the position information is displayed only for a predetermined time, a user's operation for designating the designation point is not likely to be interfered with. Therefore, the endoscopic device 1 can suppress deterioration in the operability of the device.

While the designation point information is displayed, designation point setting unit 74 stops setting the designation points. Therefore, the endoscopic device 1 urges a user to confirm the position of the designation point.

### Third Embodiment

A third embodiment of the present invention will be described using the endoscopic device 1 of the first embodiment. The display control unit 77 causes the cursor to be displayed on the image on the basis of the position information (mark position information) of the cursor which is input to the operation unit 6. The position information of the cursor indicates the position of the cursor on the image. When an instruction for designating a designation point is input to the operation unit 6, the designation point setting unit 74 sets one designation point included in a plurality of designation points at the position of the cursor indicated by the position information of the cursor. A non-display period is provided on the basis of the movement of the cursor.

The non-display period includes the entirety of a period in which the cursor moves on the image. When the mark during movement stops, the non-display period ends.

When the cursor starts to move, the non-display period starts. While the cursor moves on the image, the non-display period continues. When the cursor is stopped, the non-display period ends. While the cursor moves, it is difficult for a user to accurately designate a designation point. Therefore, a user stops the cursor and designates the designation point. After the cursor is stopped, the display control unit 77 causes the monitor 4 to display the designation point information.

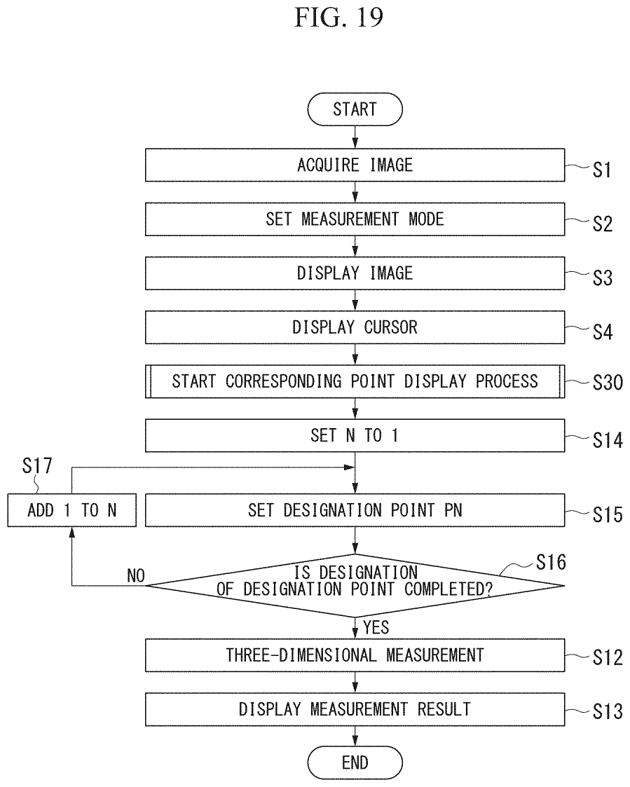

FIG. 19 shows a procedure of the measurement process. The same process as the process shown in FIG. 8 will not be described.

After step S4, a corresponding point display process starts (step S30). Here, as the designation point information, an example is shown in a case where a corresponding point image generated by cutting out a region including a corresponding point from the image is displayed. The corresponding point display process will be described later. After the corresponding point display process starts, the process in step S14 is executed.

In step S16, in a case where the timing determination unit 71 determines that the designation of designation points is not completed, the process in step S17 is executed similarly to the process shown in FIG. 8. In step S16, in a case where the timing determination unit 71 determines that the designation of designation points has been completed, the process in step S12 is executed.

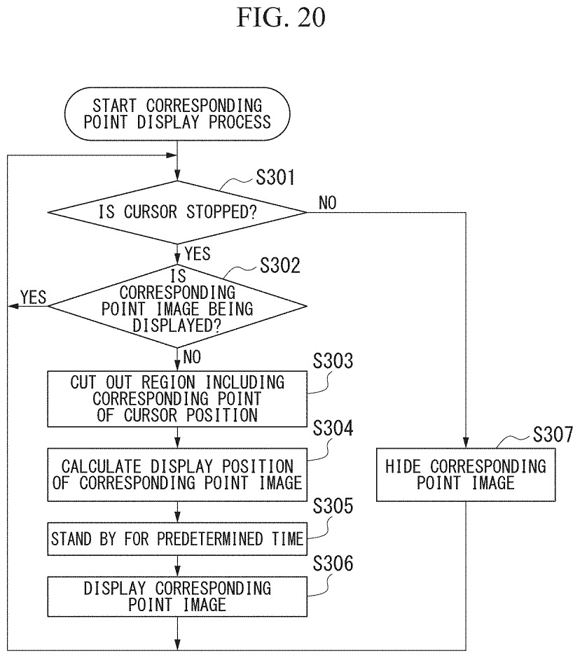

FIG. 20 shows a procedure of the corresponding point display process in step S30. The corresponding point display process shown in FIG. 20 is executed in parallel with the measurement process shown in FIG. 19.

The cursor position detection unit 78 monitors the position of the cursor and determines whether or not the cursor is stopped (step S301).

In step S301, in a case where the cursor position detection unit 78 determines that the cursor is stopped, the control unit 73 determines whether or not the corresponding point image is being displayed (step S302). The corresponding point image is an image of a region including the corresponding point of the position of the cursor. The corresponding point image is a portion of the second image.

In step S302, in a case where the control unit 73 determines that the corresponding point image is being displayed, the process in step S301 is executed. In step S302, in a case where the control unit 73 determines that the corresponding point image is not being displayed, the measurement unit 76 calculates the corresponding point of the position of the cursor by executing the matching process. The information generation unit 70 accepts the corresponding point information calculated by the measurement unit 76 from the control unit 73. The information generation unit 70 generates the corresponding point image by cutting out a region including the corresponding point from the second image (step S303).

After the corresponding point image is generated, the display position calculation unit 72 calculates the display position of the corresponding point image S304). The display position calculation unit 72 calculates a region in which the corresponding point image and the cursor do not overlap each other in the vicinity of the position of the cursor. The display position calculation unit 72 notifies the control unit 73 of coordinate information of the region. The control unit 73 notifies the display control unit 77 of the coordinate information of the region in which the corresponding point image is displayed.

After the display position of the corresponding point image is calculated, the timing determination unit 71 stands by for a predetermined time (step S305). The timing determination unit 71 determines a timing at which the non-display period ends on the basis of a time having elapsed from when the process of step S304 is executed. When the predetermined time has elapsed, the timing determination unit 71 determines that the non-display period ends. That is, the timing determination unit 71 determines that the corresponding point image is displayed. The tinting determination unit 71 notifies the control unit 73 of a determination result. The control unit 73 instructs the display control unit 77 to display the corresponding point image on the basis of the determination result.

In step S305, information of a predetermined time is used. The information of the predetermined time is used in the determination of a timing at which the non-display period ends. For example, the information of the predetermined time is recorded in advance in the memory of the endoscopic device 1. A user may input the information of the predetermined time to the operation unit 6.

After the predetermined time has elapsed, the display control unit 77 causes the monitor 4 to display the corresponding point image. The monitor 4 displays the corresponding point image on the first image (step S306). After the corresponding point image is displayed, the process in step S301 is executed. Meanwhile, in step S305, while the timing determination unit 71 stands by for the predetermined time, the display control unit 77 may prohibit the movement of the cursor. In that case, the display control unit 77 may enable the movement of the cursor after step S306. In addition, in a case where the display control unit 77 accepts the movement of the cursor during standby in step S305, the display control unit 77 may confirm whether or not the cursor moves during the execution of the process of step S305. In a case where the cursor moves during the execution of the process of step S305, the process may transition to step S301 forcibly.

In step S301, in a case where the cursor position detection unit 78 determines that the cursor is not stopped, the display control unit 77 causes the corresponding point image to be hidden (step S307). The monitor 4 stops displaying the corresponding point image. After the corresponding point image is hidden, the process in step S301 is executed. In a case where the cursor is not stopped and the corresponding point image is already hidden, the process in step S307 is not executed.

According to the corresponding point display process shown in FIG. 20, when the cursor starts to move, the corresponding point image is hidden through the process in step S307. While the cursor moves, the non-display period continues. That is, the corresponding point image is not displayed. When the cursor is stopped, the non-display period ends. That is, the corresponding point image is displayed through the processes in steps S303 to S306. When the cursor starts to move again, the corresponding point image is hidden through the process in step S307.

Generally, when the cursor is stopped, a user designates a designation point. When a user designates the designation point, the corresponding point image is displayed. The corresponding point image is equivalent to the designation point information.

In step S16, in a case where the timing determination unit 71 determines that the designation of designation points has been completed, the corresponding point display process shown in FIG. 20 may end. While the cursor moves, the designation point settings unit 74 may stop setting the designation point regardless of a users operation for designating the designation point. For example, while the cursor moves, the designation point setting unit 74 does not accept the designation of the designation point.

There are various aspects of processes executed after the designation of all the designation points is completed. For example, after the designation of all the designation points is completed, the designation point information of each of all the designation points may be displayed. After the designation of all the designation points is completed, the designation point information of each of all the designation points may be displayed only for a predetermined time. After the designation of all the designation points is completed, the designation point information of only a designation point having low reliability may be displayed.

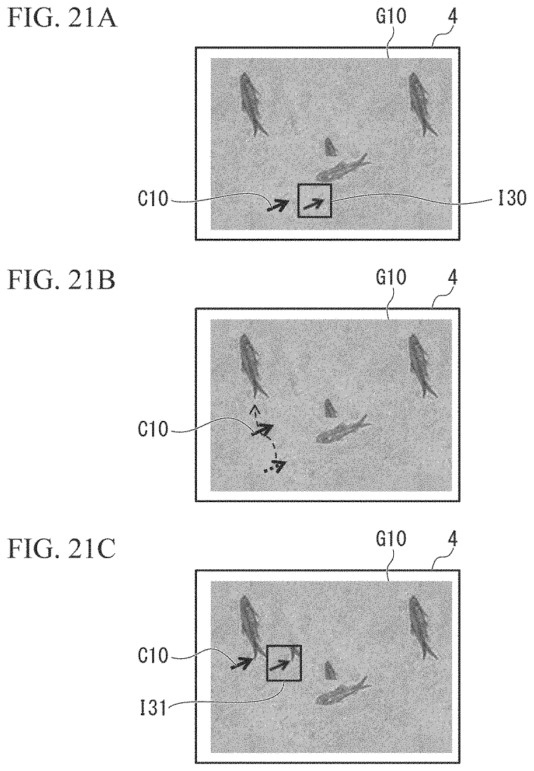

FIGS. 21A to 25 show the states of the monitor 4 when the measurement process shown in FIG. 19 is executed. In step S3, the first image G10 shown in FIG. 21A is displayed on the monitor 4. In step S4, the cursor C10 shown in FIG. 21A is displayed on the first image G10. When the cursor C10 is displayed first, the cursor C10 is stopped. Therefore, in step S306, a corresponding point image I30 shown in FIG. 21A is displayed on the first image G10. The corresponding point image I30 does not overlap the cursor C10.

A user moves the cursor C10 on the first image G10 by operating the operation unit 6. When the cursor C10 starts to move, the corresponding point image I30 is hidden in step S307. While the cursor C10 moves,the corresponding point image is not displayed (FIG. 21B). When the cursor C10 is stopped and a predetermined time has elapsed, a corresponding point image I31 shown in FIG. 21C is displayed on the first image G10 in step S306. The corresponding point image I31 does not overlap the cursor C10.

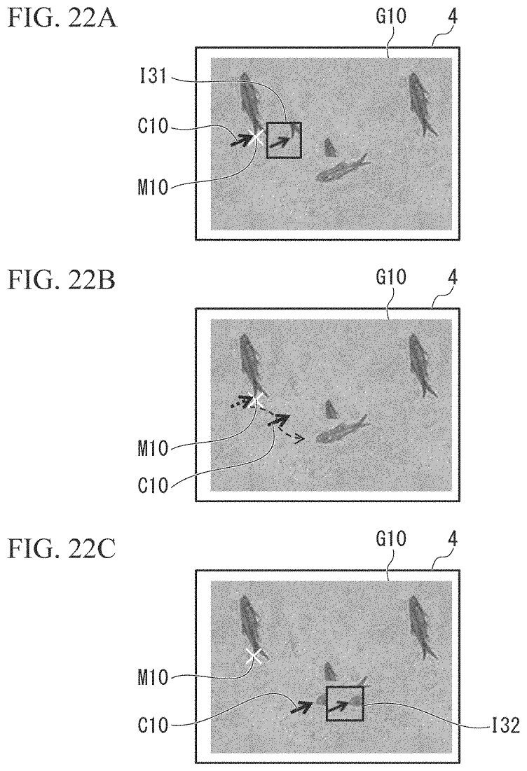

When the designation point is set on the first image G10 in step S15, the mark M10 shown in FIG. 22A is displayed on the first image G10. The position of the mark M10 is the same as the position of the cursor C10. The mark M10 does not overlap the corresponding point image I31. When a user designates a designation point, the corresponding point image I31 indicates a peripheral region of the corresponding point of the designation point. A user compares a designation point indicated by the mark M10 with a corresponding point indicated by the corresponding point image I31. The corresponding point image I31 is designation point information. Insofar as the cursor C10 does not above after a user designates the designation point, the corresponding point image I31 continues to be displayed.

A user moves the cursor C10 on the first image G10 by operating the operation unit in order to designate the next designation point. When the cursor C10 starts to move, the corresponding point image I31 is hidden in step S307. While the cursor C10 moves, the corresponding point image is hidden (FIG. 22B). When the cursor C10 is stopped and a predetermined time has elapsed, a corresponding point image I32 shown in FIG. 22C is displayed on the first image G10 in step S306. The corresponding point image I32 does not overlap the cursor C10.

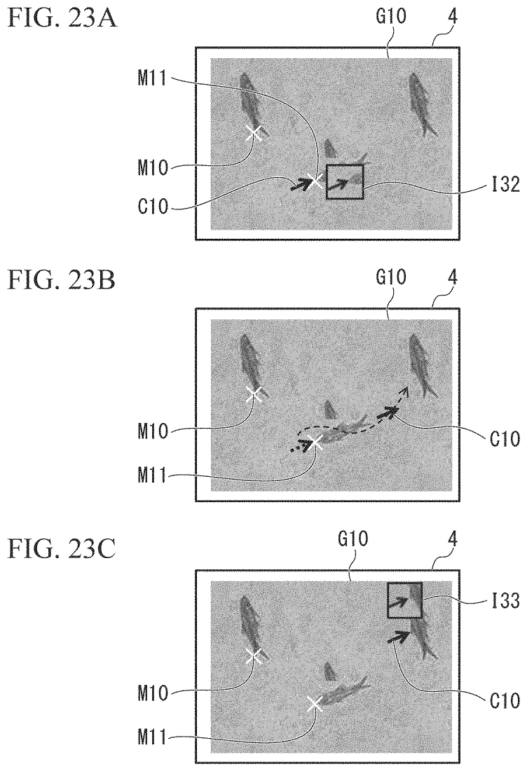

When the designation point is set on the first image G10 in step S15, the mark M11 shown in FIG. 23A is displayed on the first image G10. The position of the mark M11 is the same as the position of the cursor C10. The mark M11 does not overlap the corresponding point image I32. When a user designates a designation point, the corresponding point image I32 indicates a peripheral region of the corresponding point of the designation point. A user compares a designation point indicated by the mark M11 with a corresponding point indicated by the corresponding point image I32. The corresponding point image I32 is designation point information. Insofar as the cursor C10 does not move after a user designates the designation point, the corresponding point image I32 continues to be displayed.

A user moves the cursor C10 on the first image G10 by operating the operation unit 6 in order to designate the next designation point. When the cursor C10 starts move, the corresponding point image I32 is hidden in step S307. While the cursor C10 moves, the corresponding point image is hidden (FIG. 23B). When the cursor C10 is stopped and a predetermined time has elapsed, a corresponding point image I33 shown in FIG. 23C is displayed on the first image G10 in step S306. The corresponding point image I33 does not overlap the cursor C10.

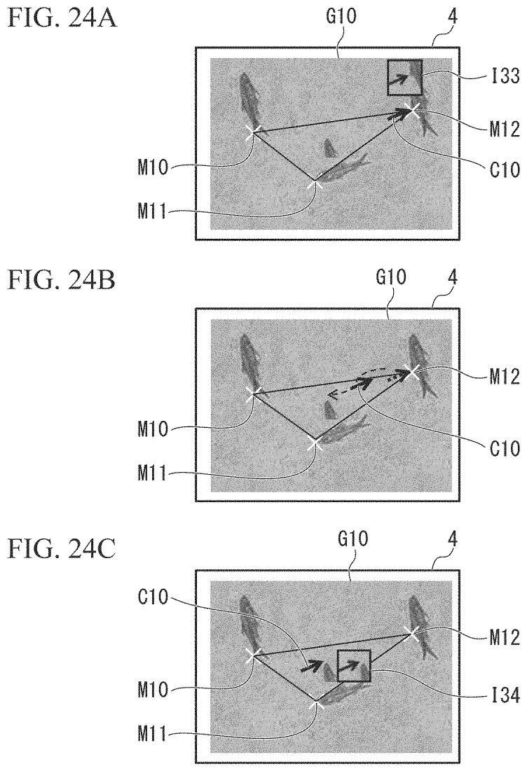

When the designation point is set on the first image G10 in step S15, the mark M12 shown in FIG. 24A is displayed on the first image G10. The position of the mark M12 is the same as the position of the cursor C10. The mark M12 does not overlap the corresponding point image I33. When a user designates a designation point, the corresponding point image I33 indicates a peripheral region of the corresponding point of the designation point. A user compares a designation point indicated by the mark M12. with a corresponding point indicated by the corresponding point image I33. The corresponding point image I33 is designation point information. Insofar as the cursor C10 does not move after a user designates the designation point, the corresponding point image I33 continues to be displayed.

A user moves the cursor C10 on the first image G10 by operating the operation unit 6 in order to designate the next designation point. When the cursor C10 starts to move, the corresponding point image I33 is hidden in step S307. While the cursor C10 moves, the corresponding point image is not displayed (FIG. 24B). When the cursor C10 is stopped and a predetermined time has elapsed, a corresponding point image I34 shown in FIG. 24C is displayed on the first image G10 in step S306. The corresponding point image I34 does not over lap the cursor C10.

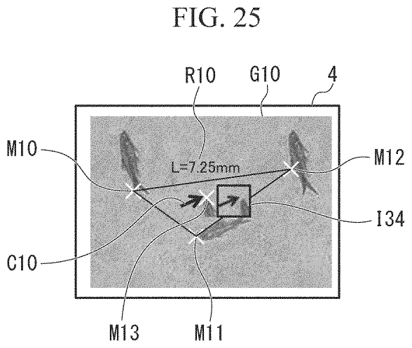

When the designation point is set on the first image G10 in step S15, the mark M13 shown in FIG. 25 is displayed on the first image G10. The position of the mark M13 is the same as the position of the cursor C10. The mark M13 does not overlap the corresponding point image I34. When a user designates a designation point, the corresponding point image I34 indicates a peripheral region of the corresponding point of the designation point. A user compares a designation point indicated by the mark M13 with a corresponding point indicated by the corresponding point image I34. The corresponding point image I34 is designation point information. In a case where the plane-based measurement is set in the endoscopic device 1, the designation of all the designation points is completed when four designation points are set. In step S13, the measurement result R10 shown in FIG. 25 is displayed on the first image G10.

There are various display positions of the designation point information designation point information does not overlap each designation point. In order for a user to compare the position of the designation point with the position of the corresponding point, the designation point information may be displayed at a position away from the designation point in a horizontal direction or a vertical direction. The measurement result may be displayed at a position where the result does not overlap the designation point information. A plurality of pieces of designation point information may be displayed at positions where these pieces of designation point information do not overlap one another. The designation point information may be displayed at a position where the information does not overlap a straight line that links one designation point to another designation point.

In the endoscopic device 1 of the third embodiment, after the cursor is stopped, the display control unit 77 causes the monitor 4 to display the designation point information. When a user stops the cursor in order to designate a designation point, the user can determine whether or not the position of the designation point is suitable for the measurement of a subject in real time.

After predetermined time has elapsed from when the cursor is stopped, the display control unit 77 causes the monitor 4 to display the designation point information. While the cursor moves, the designation point information is not displayed. In addition, until the predetermined time has elapsed from when the cursor is stopped, the designation point information is not displayed. Therefore, even in a case where a user repeats the movement of the cursor and the stop of the cursor momentarily within a certain amount of time, it is possible to prevent the designation point information from being displayed every time and the user's operation for designating the designation point not likely to be interfered with. As a result, the endoscopic device 1 can suppress deterioration in the operability of the device.

While a user performs an operation for designating a designation point, the designation point information of the designation point which is already set is not displayed and only the designation point information of the position of the cursor is displayed. Therefore, a user's operation for designating the designation point is not likely to be interfered with. As a result, the endoscopic device 1 can suppress deterioration in the operability of the device.

While the cursor moves, the designation point setting unit 74 stops setting the designation points. Only when the cursor is stopped, a user can designate the designation point. Therefore, a user can accurately designate the designation point.

### Modification Example of Third Embodiment

A modification example of the third embodiment of the present invention will be described below. The non-display period includes the entirety of a period in which the cursor moves on the image. When an instruction for designating the first designation point is input to the operation unit 6, the non-display period ends. After the instruction for designating the first designation point is input to the operation unit 6, the non-display period starts on the basis of the movement of the cursor. When an instruction for designating the second designation point is input to the operation unit 6, the non-display period ends.

When the cursor starts to move, the non-display period starts. When the designation point information is displayed, the non-display period ends. While cursor moves, it is difficult for a user to accurately designate designation point. Therefore, a user stops the cursor and designates the designation point. After the designation point is designated, the display control unit 77 causes the monitor 4 to display the designation point information.

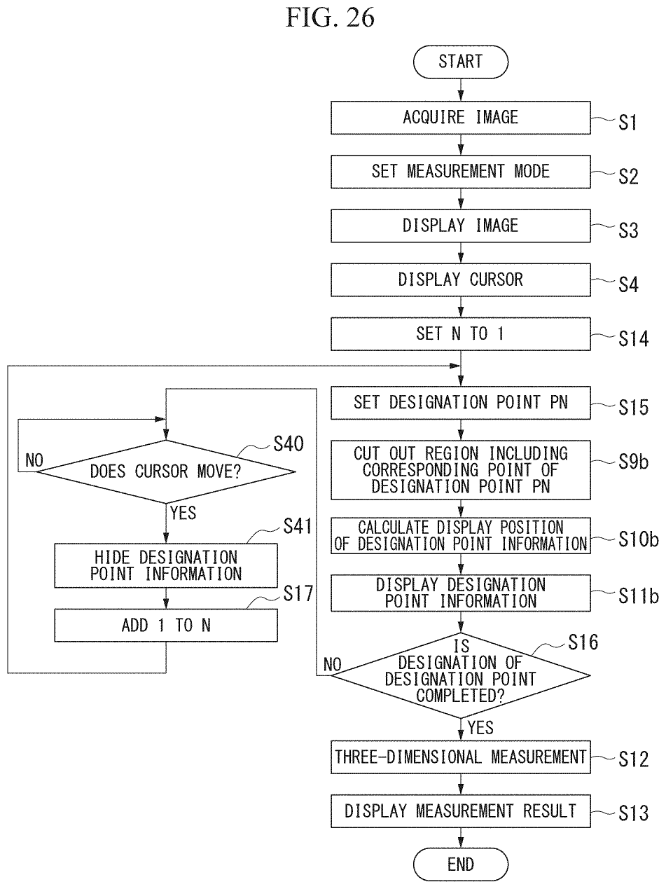

FIG. 26 shows a procedure of the measurement process. The same process as the process shown in FIG. 13 will not be described.

Similarly to the measurement process shown in FIG. 13, after the designation point PN is set in step S15, the process in each of steps S9b, S10b, and S11b is executed. In step S11b, the designation point information is displayed on the image. After the designation point information is displayed, the timing determination unit 71 determines whether or not the designation of designation points has been completed in step S16.

In step S16, in a case where the timing determination unit 71 determines that the designation of designation points has been completed, the process in step S12 is executed similarly to the measurement process shown in FIG. 13. In step S16, in a case where the timing determination unit 71 determines that the designation of designation points is not completed, the cursor position detection unit 78 monitors the position of the cursor and determines whether or not the cursor has moved (step S40).

In step S40, in a case where the timing determination unit 71 determines that the cursor is stopped, the determination in step S40 continues. In step S40, in a case where the timing determination unit 71 determines that the cursor moves, the timing determination unit 71 determines that the non-display period starts. That is, the timing determination unit 71 determines that the designation point information is to be hidden. The timing determination unit 71 notifies the control unit 73 of a determination result. The control unit 73 instructs the display control unit 77 to hide the designation point information on the basis of the determination result.

The display control unit 77 causes the designation point information to be hidden (step S41). The monitor 4 stops displaying the designation point information. After the designation point information is hidden, the process in step S17 is executed.

When the measurement process shown in FIG. 26 starts, the non-display period starts. When the designation point information is displayed in step S11b, the non-display period ends. When the cursor moves, the designation point information is hidden in step S41. In this case, the non-display period starts. After a user stops the cursor and designates a designation point, the designation point information is displayed in step S11b. In this case, the non-display period ends.

While the cursor moves, the designation point setting unit 74 may stop setting the designation point regardless of a user's operation for designating the designation point. For example, while the cursor moves, the designation point setting unit 74 does not accept the designation of the designation point.

There are various aspects of processes executed after the designation of all the designation points is completed. For example, after the designation of all the designation points is completed, the designation point information each of all the designation points may be displayed only for a predetermined time. After the designation of all the designation points is completed, the designation point information of only a designation point having low reliability may be displayed.

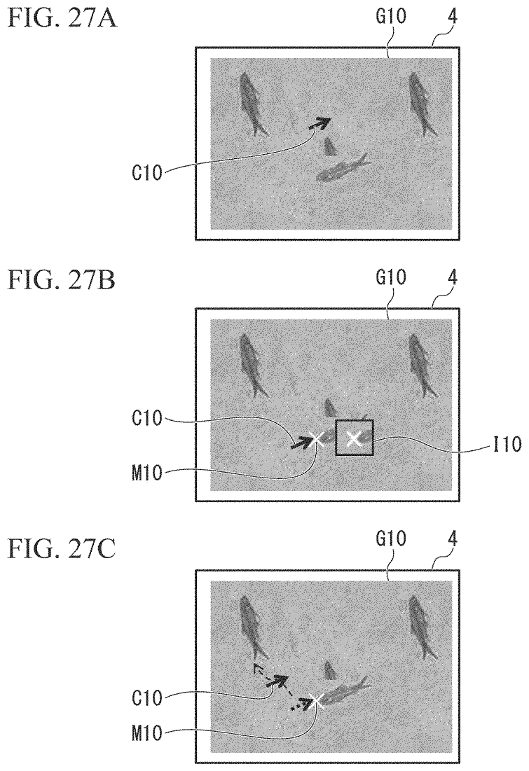

FIGS. 27 to 30 show the states of the monitor 4 when the measurement process shown in FIG. 26 is executed. In step S3, the first image G10 shown in FIG. 27A is displayed on the monitor 4. In step S4, the cursor C10 shown in FIG. 27A is displayed on the first image G10.

A user moves the cursor C10 on the first image G10 by operating the operation unit 6. When the designation point is set on the first image G10 in step S15, the mark M10 shown in FIG. 27B is displayed on the first image G10. The position of the mark M10 is the same as the position of the cursor C10. Thereafter, in step S11b, the designation point information I10 shown in FIG. 27B is displayed on the first image G10. The designation point information I10 does not overlap the mark M10. A user compares a designation point indicated by the mark M10 with a corresponding point indicated by the designation point information I10. While the cursor C10 is stopped, the designation point information I10 continues to be displayed.

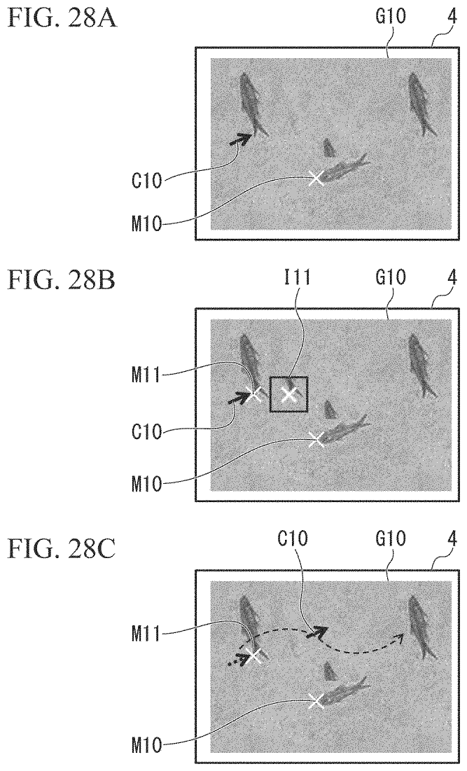

A user moves the cursor C10 on the first image G10 by operating the operation unit 6 in order to designate the next designation point. When the cursor C10 starts to move, the designation point information I10 is hidden in step S41. While the cursor C10 moves, the designation point information is hidden (FIG. 27C). A user stops the cursor C10 at a position where the designation point is desired to be designated (FIG. 28A).

When the designation point is set on the first image G10 in step S15, the mark M11 shown in FIG. 28B is displayed on the first image G10. The position of the mark M11 is the same as the position of the cursor C10. Thereafter, in step S11b, the designation point information I11 shown in FIG. 28B is displayed on the first image G10. The designation point information I11 does not overlap the mark M11. A user compares a designation point indicated by the mark M11 with a corresponding point indicated by the designation point information I11. While the cursor C10 is stopped, the designation point information I11 continues to be displayed.

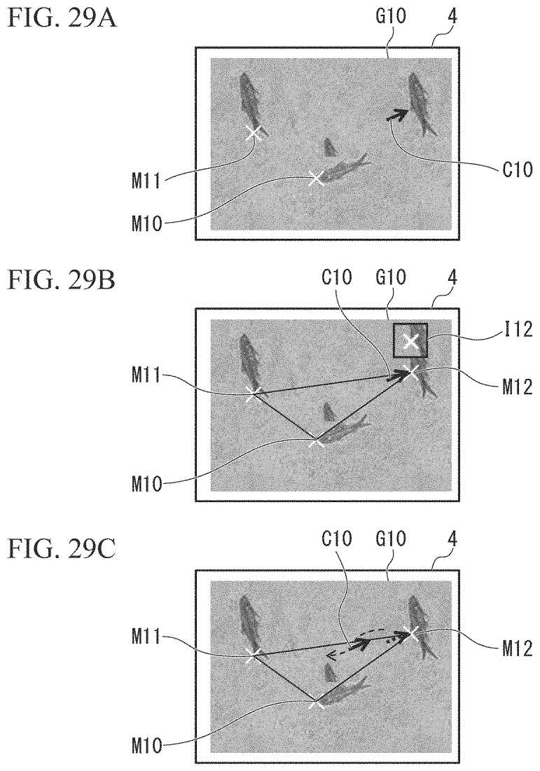

A user moves the cursor C10 on the first image G10 by operating the operation unit 6 in order to designate the next designation point. When the cursor C10 starts move, the designation point information I11 is hidden in step S41. While the cursor C10 moves, the designation point information is hidden (FIG. 28C). A user stops the cursor C10 at a position where the designation point is desired to be designated (FIG. 29A).

When the designation point is set on the first image G10 in step S15, the mark M12 shown in FIG. 29B is displayed on the first image G10. The position of the mark M12 is the same as the position of the cursor C10. Thereafter, in step S11b, the designation point information I12 shown in FIG. 29B is displayed on the first image G10. The designation point information I12 does not overlap the mark M12. A user compares a designation point indicated by the mark M12 with a corresponding point indicated by the designation point information I12. While the cursor C10 is stopped, the designation point information I12 continues to be displayed.

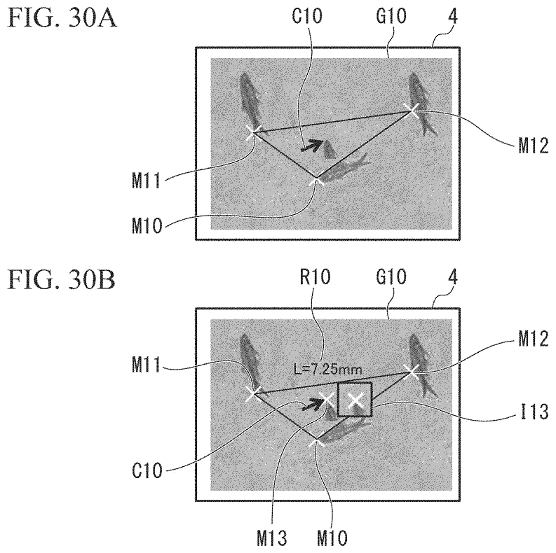

A user moves the cursor C10 on the first image G10 by operating the operation unit 6 in order to designate the next designation point. When the cursor C10 starts to move, the designation point information I12 is hidden in step S41. While the cursor C10 moves, the designation point information is not displayed (FIG. 29C). A user stops the cursor C10 at a position there the designation point is desired to be designated (FIG. 30A).

When the designation point is set on the first image G10 in step S15, the mark M13 shown in FIG. 30B is displayed on the first image G10. The position of the mark M13 is the same as the position of the cursor C10. Thereafter, in step S11b, the designation point information I13 shown in FIG. 30B is displayed on the first image G10. The designation point information I13 does not overlap the mark M13. A user compares a designation point indicated by the mark M13 with a corresponding point indicated by the designation point information I13. In a case where the plane-based measurement is set in the endoscopic device 1, the designation of all the designation points is completed when four designation points are set. In step S13, the measurement result R10 shown in FIG. 30B is displayed on the first image G10.

There are various display positions of the designation point information. The designation point information does not overlap each designation point. In order for a user to easily compare the position of the designation point with the position of the corresponding point, the designation point information may be displayed at a position away from the designation point in a horizontal direction or a vertical direction. The measurement result may be displayed at a position where the result does not overlap the designation point information. A plurality of pieces of designation point information may be displayed at positions where these pieces of designation point information do not overlap one another. The designation point information may be displayed at a position where the information does not overlap a straight line that links one designation point to another designation point.

In the endoscopic device 1 of the modification example of the third embodiment, after the cursor is stopped and an instruction for designating a designation point is input to the operation unit 6, the display control unit 77 causes the monitor 4 to display the designation point information. When a user searches for a designation point, the designation point information is hidden, and thus a user's operation for designating the designation point is not likely to be interfered with. As a result, the endoscopic device 1 can suppress deterioration in the operability of the device.

The designation point information is displayed every time the designation point is designated. A user can confirm the position of the designation point every time the designation point is designated and can determine the validity of the designation point for each point.

While preferred embodiments of the invention have been described and shown above, it should be understood that these are exemplars of the invention and are not to be considered as limiting. Additions, omissions, substitutions, and other modifications be made without departing from the spirit or scope of the present invention. Accordingly, the invention is not to be considered as being limited by the foregoing description, and is only limited by the scope of the appended claims.

What is claimed is:

1. A measurement device comprising:
an image acquisition unit that acquires an image of a subject;
a designation point setting unit that sets a plurality of designation points on the image on the basis of position information which is input to an input device, the position information indicating a position of each designation point of the plurality of designation points in the image;
a display control unit that causes a display unit to display the image and designation point information, the designation point information indicating whether or not a position of at least one designation point included in the plurality of designation points is suitable for measurement of the subject; and
a measurement unit that executes the measurement on the basis of the plurality of designation points,
wherein after the position information of the at least one of the designation points included in the plurality of designation points is input to the input device, the display control unit causes the display unit to display the designation point information in only a period except a non-display period, the non-display period including at least a portion of a period from a first timing to a second timing, the first timing being a timing at which the position information of a first designation point included in the plurality of designation points is input to the input device, the second timing being a timing at which the position information of a second designation point included in the plurality of designation points is input to the input device, and the second designation point being different from the first designation point.

2. The measurement device according to claim 1,
wherein the position information of the first designation point out of the plurality of designation points is input to the input device first,
the position information of the second designation point out of the plurality of designation points is input to the input device last, and
the non-display period includes the entirety of the period from the first timing to the second timing.

3. The measurement device according to claim 2, further comprising a determination unit that determines whether or not the position information of the second designation point has been input to the input device on the basis of a measurement mode,
wherein when the determination unit determines at the position information of the second designation point has been input to the input device, the non-display period ends, and
the measurement unit executes measurement of the subject using a method based on the measurement mode.

4. The measurement device according to claim 1,
wherein after the position information of the first designation point is input to the input device, the display control unit causes the display unit to display the designation point information of the first designation point,
after the designation point information of the first designation point is displayed, the display control unit causes the designation point information of the first designation point to be hidden, and
the non-display period includes the entirety of a period from a third timing to the second timing, the third timing being a timing at which the designation point information of the first designation point is hidden.

5. The measurement device according to claim 4,
wherein until a predetermined time elapses after the position information of the first designation point is input to the input device, the display control unit causes the display unit to display the designation point information.

6. The measurement device according to claim 5,
wherein while the designation point information is displayed, the designation point setting unit stops setting the designation points.

7. The measurement device according to claim 1,
wherein the display control unit further causes a mark to be displayed on the image on the basis of mark position information which is input to the input device, the mark position information indicating a position of the mark on the image,
when an instruction for designating the designation point is input to the input device, the designation point setting unit sets one designation point included in the plurality of designation points at the position of the mark indicated by the mark position information, and
the non-display period is provided on the basis of movement of the mark.

8. The measurement device according to claim 7,
wherein the non-display period includes the entirety of a period in which the mark moves on the image, and
when the mark during movement stops, the non-display period ends.

9. The measurement device according to claim 7,
wherein the non-display period includes the entirety of a period in which the mark moves on the image,
when the instruction for designating the first designation point is input to the input device, the non-display period ends,
after the instruction for designating the first designation point is input to the input device, the non-display period starts on the basis of movement of the mark, and
when the instruction for designating the second designation point is input to the input device, the non-display period ends.

10. The measurement device according to claim 7,
wherein while the mark moves, the designation point setting unit stops setting the designation points.

11. The measurement device according to claim 1,
wherein the display control unit causes the designation point information to be displayed at a position where the designation point information does not overlap the plurality of designation points.

12. The measurement device according to claim 1,
wherein the image acquisition unit acquires a first image and a second image mutually having a parallax,
the designation point setting unit sets the plurality of designation points on the first image,
the display control unit causes the display unit to display the first image and the designation point information, and
the designation point information is at least a portion of the second image.

13. A method of operating a measurement device, comprising:
a first step in which an image acquisition unit acquires an image of a subject;
a second step in which a designation point setting unit sets a plurality of designation points on the image on the basis of position information which is input to an input device, the position information indicating a position of each designation point of the plurality of designation points in the image;
a third step in which a display control unit causes a display unit to display the image;
a fourth step in which a measurement unit executes measurement of the subject on the basis of the plurality of designation points; and
a fifth step in which the display control unit causes the display unit to display designation point information in a period except a non-display period after the position information of at least one designation point included in the plurality of designation points is input to the input device, the designation point information indicating whether or not a position of the at least one designation point included in the plurality of designation points is suitable for the measurement, the non-display period including at least a portion of a period from a first timing to a second timing, the first timing being a timing at which the position information of a first designation point included in the plurality of designation points is input to the input device, the second timing being a timing at which the position information of a second designation point included in the plurality of designation points is input to the input device, and the second designation point being different from the first designation point.

14. A computer readable non-transitory recording medium having a program recorded therein, the program causing a computer to execute:
a first step of acquiring an image of a subject;
a second step of setting a plurality of designation points on the image on the basis of position information which is input to an input device, the position information indicating a position of each designation point of the plurality of designation points in the image;
a third step of causing a display unit to display the image;
a fourth step of executing measurement of the subject on the basis of the plurality of designation points; and
a fifth step of causing the display unit to display designation point information in a period except a non-display period after the position information of at least one designation point included in the plurality of designation points is input to the input device, the designation point information indicating whether or not a position of the at least one designation point included in the plurality of designation points is suitable for the measurement, the non-display period including at least a portion of a period from a first timing to a second timing, the first timing being a timing at which the position information of a first designation point included in the plurality of designation points is input to the input device, the second timing being a timing at which the position information of a second designation point included in the plurality of designation points is input to the input device, and the second designation point being different from the first designation point.
